(19) United States
(12) Patent Application Publication
(10) Pub. No.: US 2026/0321933 A1
(43) Pub. Date: Oct. 15, 2026

(54) BATTERY PACKAGE AND BATTERY MODULE

(71) Applicant: KYOCERA Corporation, Kyoto-shi, Kyoto (JP)

(72) Inventor: Koutarou NAKAMOTO, Kyoto-shi (JP)

(73) Assignee: KYOCERA Corporation, Kyoto-shi, Kyoto (JP)

(21) Appl. No.: 19/114,662

(22) PCT Filed: Sep. 19, 2023
(86) PCT No.: PCT/JP2023/033825

§ 371 Date: Mar. 24, 2025

(30) Foreign Application Priority Data
Sep. 26, 2022 (JP) 2022-152936

(51) Int. Cl. H01M 50/593; H01M 50/109; H01M 50/588

(52) U.S. Cl. CPC H01M 50/593; H01M 50/109; H01M 50/588

(57) ABSTRACT

A battery module according to the present disclosure that implements a battery module that is less likely to discharge externally includes an insulating substrate including a first surface, a second surface located opposite to the first surface, and a recessed portion opening to the first surface, a first electrode located on a bottom surface of the recessed portion, a conductive elastic member located on the first electrode, and a conductive member that comes into contact with an upper surface electrode of a battery accommodated in the recessed portion. The insulating substrate includes a fixing portion that limits movement of the conductive member in a direction away from the bottom surface of the recessed portion.

### TECHNICAL FIELD

The present disclosure relates to a battery package and a battery module.

### BACKGROUND OF INVENTION

Various forms of power supplies that can be surface mounted on a mounting substrate together with electronic circuit components have been proposed as power supplies or auxiliary power supplies for small electronic devices.

Patent Document 1 discloses an electrochemical cell in which an electrochemical element is accommodated in a housing space of a sealed container. The sealed container has a base member on which a first current collector is formed and a lid member which is fixed to the base member and on which a second current collector is formed, and a housing space is defined between both members. The electrochemical element has a first electrode (lower surface electrode) and a second electrode (upper surface electrode). An elastic member is disposed between the lid member and the second electrode in the housing space, the elastic member pressing the second electrode toward the first electrode and electrically connecting the second electrode and the second current collector.

### CITATION LIST

### Patent Literature

Patent Document 1: JP 2012-69508 A

### SUMMARY

In an aspect of the present disclosure, a battery package includes an insulating substrate including a first surface, a second surface located opposite to the first surface, and a recessed portion opening to the first surface; a first external electrode located on the second surface; a second external electrode located on the second surface; a first electrode located on a bottom surface of the recessed portion and electrically connected to the first external electrode; a second electrode located on the insulating substrate and electrically connected to the second external electrode; a conductive elastic member located on the first electrode; and a conductive member configured to come into contact with an upper surface electrode of a battery accommodated in the recessed portion and to electrically connect the upper surface electrode and the second electrode, wherein the insulating substrate includes a fixing portion configured to limit movement of the conductive member in a direction away from the bottom surface of the recessed portion.

In an aspect of the present disclosure, a battery module includes the battery package according to an aspect of the present disclosure; and a battery accommodated in a recessed portion of the battery package.

### BRIEF DESCRIPTION OF THE DRAWINGS

FIG. 1 is a perspective view illustrating an external appearance of an example of a battery module according to a first embodiment.

FIG. 2 is an exploded perspective view of the battery module of FIG. 1.

FIG. 3 is a plan view illustrating an example of the battery module of FIG. 1 in a state in which a lid is removed.

FIG. 4 is a cross-sectional view taken along line IV in FIG. 3.

FIG. 5 is a bottom view illustrating an example of the battery module of FIG. 1.

FIG. 6 is a bottom view of the battery module of FIG. 1 illustrating a state in which a seal pattern is formed on a second surface of an insulating substrate.

FIG. 7 is a cross-sectional view illustrating an example of an elastic member.

FIG. 8 is a perspective view illustrating an example of an elastic member.

FIG. 9 is a perspective view illustrating an example of an elastic member.

FIG. 10 is a cross-sectional view illustrating an example of an elastic member.

FIG. 11 is a cross-sectional view of the battery module of FIG. 1 illustrating a state of having a metal frame body.

FIG. 12 is a plan view illustrating another state of a locking portion included in an insulating substrate.

FIG. 13 is a plan view illustrating another state of a locking portion provided in an insulating substrate.

FIG. 14 is a cross-sectional view taken along line XIV in FIG. 13.

FIG. 15 is a cross-sectional view illustrating a state of assembling the battery module of FIG. 1 having an inclined surface in a locking portion.

FIG. 16 is a cross-sectional view illustrating a state of assembling the battery module of FIG. 1 having a stepped surface in a locking portion.

FIG. 17 is a plan view illustrating a state of assembling the battery module of FIG. 1 in which a notch opens to a first surface and a recessed portion on the side of a locking portion.

FIG. 18 is a cross-sectional view taken along lines XVIII-A and XVIII-B in FIG. 17.

FIG. 19 is a cross-sectional view illustrating another example of engagement between a fixed portion and a locking portion.

FIG. 20 is a cross-sectional view taken along lines XX-A and XX-B in FIG. 17.

FIG. 21 is a partially enlarged cross-sectional view of a battery module using a thin-film type all-solid-state battery as a battery.

FIG. 22 is a partially enlarged cross-sectional view of a battery module using a plurality of thin-film type all-solid-state batteries as batteries.

FIG. 23 is a plan view illustrating another example of the battery module according to the first embodiment in a state in which a lid is removed.

FIG. 24 is a cross-sectional view taken along line XXIV in FIG. 23.

FIG. 25 is a plan view illustrating another example of the battery module according to the first embodiment in a state in which a lid is removed.

FIG. 26 is a cross-sectional view illustrating another example of the battery module according to the first embodiment.

FIG. 27 is a cross-sectional view illustrating another example of the battery module according to the first embodiment.

FIG. 28 is a plan view illustrating an example of a battery module according to a second embodiment in a state in which a lid is removed.

FIG. 29 is a cross-sectional view taken along line XXIX in FIG. 28.

FIG. 30 is a cross-sectional view taken along line XXX in FIG. 28.

FIG. 31 is a cross-sectional view of the battery module according to the second embodiment, which illustrates another state of a connection portion of a conductive member.

FIG. 32 is a cross-sectional view of the battery module according to the second embodiment, which illustrates another state of a connection portion of a conductive member.

FIG. 33 is a cross-sectional view of the battery module according to the second embodiment, which illustrates another state of a connection portion of a conductive member.

FIG. 34 is a cross-sectional view of the battery module according to the second embodiment, which illustrates another state of a fixed portion of a conductive member.

FIG. 35 is a cross-sectional view of the battery module according to the second embodiment, which illustrates another state of a fixed portion of a conductive member.

FIG. 36 is a cross-sectional view of the battery module according to the second embodiment, which illustrates another state of a fixed portion of a conductive member.

FIG. 37 is a plan view illustrating a state of assembling the battery module according to the second embodiment in which a notch opens to a first surface and a recessed portion on the side of a locking portion.

FIG. 38 is a cross-sectional view taken along line XXXVIII in FIG. 37.

FIG. 39 is a cross-sectional view taken along line XXXIX in FIG. 37.

FIG. 40 is a plan view illustrating another example of the battery module according to the second embodiment in a state in which a lid is removed.

FIG. 41 is a cross-sectional view taken along line XLI in FIG. 40.

FIG. 42 is a cross-sectional view taken along line XLII in FIG. 40.

FIG. 43 is a plan view illustrating another example of the battery module according to the second embodiment in a state in which a lid is removed.

FIG. 44 is a cross-sectional view taken along line XLIV in FIG. 43.

FIG. 45 is a cross-sectional view illustrating another example of the battery module according to the second embodiment.

FIG. 46 is a plan view illustrating another example of the battery module according to the second embodiment in a state in which a lid is removed.

FIG. 47 is a cross-sectional view taken along line XLVII in FIG. 46.

FIG. 48 is a cross-sectional view taken along line XLVIII in FIG. 46.

FIG. 49 is a plan view illustrating an example of a battery module according to a third embodiment in a state in which a lid is removed.

FIG. 50 is a cross-sectional view taken along line L in FIG. 49.

FIG. 51 is a cross-sectional view of the battery module according to the third embodiment having a metal frame body.

### DESCRIPTION OF EMBODIMENTS

In the electrochemical cell disclosed in Patent Document 1, an upper surface electrode of the electrochemical element is electrically connected to a lid member by an elastic member between the lid member and a second electrode, and is electrically connected to the outside in the lid member.

According to an aspect of the present disclosure, a battery module in which discharge from a member other than an external electrode to the outside is less likely to occur can be implemented.

A battery package and a battery module of an embodiment of the present disclosure are described with reference to the accompanying drawings. In the following description, a lid side or a first surface side of an insulating substrate in the battery package may be described as an upper side, and an insulating substrate side or a second surface side of the insulating substrate in the battery package may be described as a lower side. A vertical direction may be described as a height direction (thickness direction). This distinction between up and down is merely for the sake of convenience, and does not limit up and down when the battery module or the like is actually used.

### First Embodiment

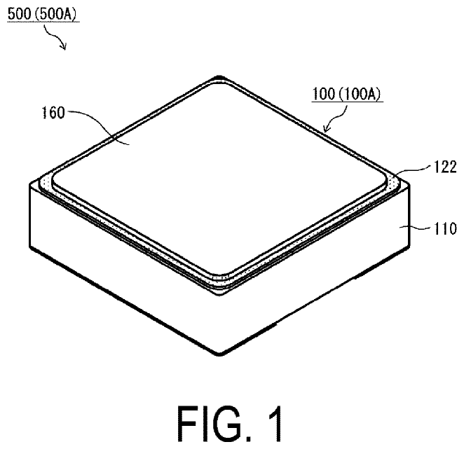

An embodiment of the present disclosure is described below with reference to FIGS. 1 to 26. Battery modules 500A and 500A1 to 500A9 to be described in the first embodiment are examples of a battery module 500 according to the present disclosure. Battery packages 100A and 100A1 to 100A9 to be described in the first embodiment are examples of a battery package 100 according to the present disclosure.

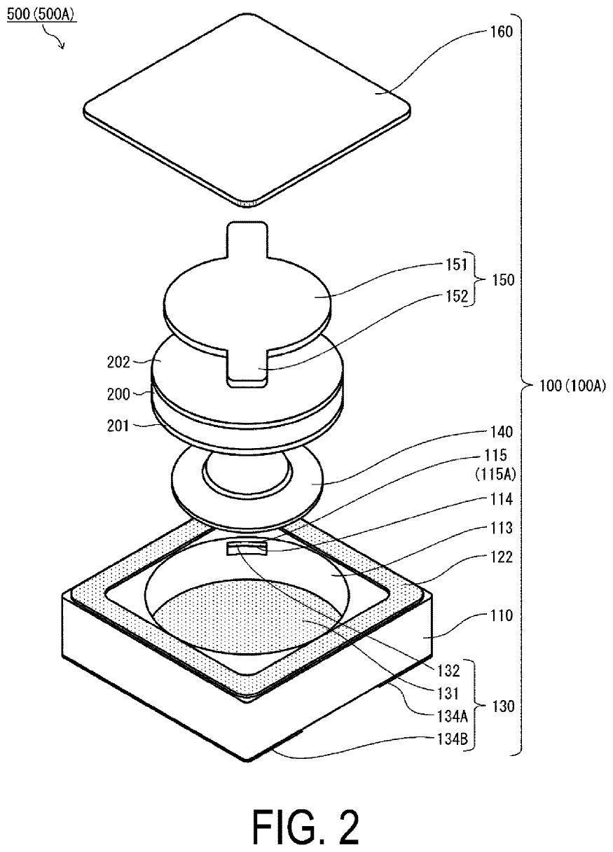

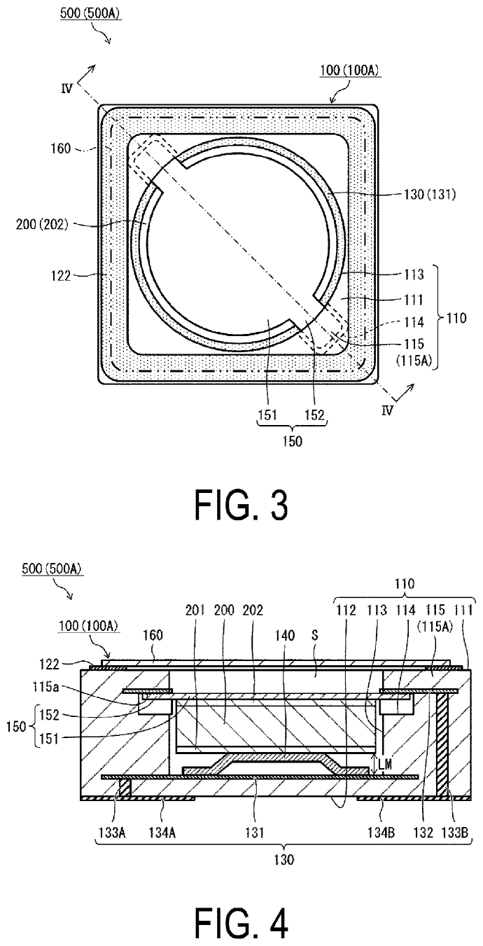

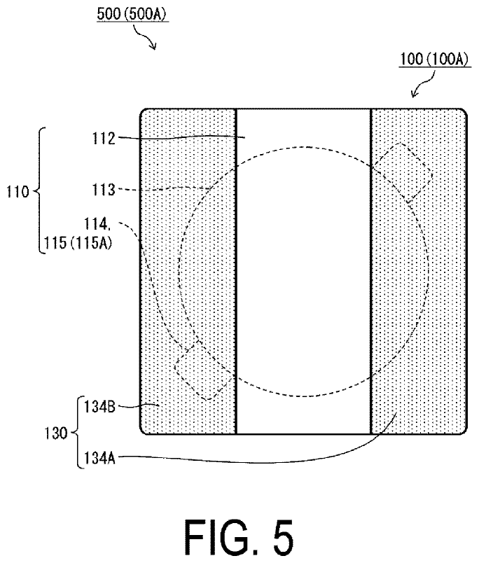

FIG. 1 is a perspective view illustrating an external appearance of an example of the battery module 500A according to the first embodiment. FIG. 2 is an exploded perspective view of the battery module of FIG. 1. FIG. 3 is a plan view illustrating an example of the battery module of FIG. 1 in a state in which a lid is removed. FIG. 4 is a cross-sectional view taken along line IV in FIG. 3. FIG. 5 is a bottom view illustrating an example of the battery module of FIG. 1. In the perspective views, the plan view, and the bottom view, a part of a first electrode or the like is shaded with dots to be easily distinguished from the others.

As illustrated in FIGS. 1 to 5, the battery module 500A includes the battery package 100A and one or more batteries 200 accommodated in a recessed portion 113 of the battery package 100A.

As illustrated in FIGS. 1 to 5, the battery package 100A may include an insulating substrate 110, a conductive elastic member 140, a conductive member 150, and a lid 160.

The insulating substrate 110 has a first surface 111, a second surface 112 located opposite to the first surface 111, and the recessed portion 113 that opens to the first surface 111. In the battery module 500A, one battery 200 is accommodated in the recessed portion 113. A plurality of batteries 200 may be accommodated in the recessed portion 113.

The insulating substrate 110 may be made of an insulating inorganic material. The insulating inorganic material includes, for example, a ceramic such as an aluminum oxide sintered body (alumina ceramic), an aluminum nitride sintered body, a mullite sintered body, or a glass ceramic sintered body. The insulating substrate 110 may be made of a plurality of layered insulating layers or one insulating layer. The insulating layer is made of an insulating material such as an aluminum oxide sintered body, a glass ceramic sintered body, a mullite sintered body, or an aluminum nitride sintered body.

When the insulating layer is made of, for example, an aluminum oxide sintered body, the insulating substrate 110 is produced in the following manner. That is, first, ceramic green sheets to be insulating layers are produced. A plurality of quadrangular sheet-shaped ceramic green sheets are produced by forming raw material powder of aluminum oxide, silicon oxide, and the like into a sheet shape together with an appropriate organic binder and organic solvent.

Subsequently, a layered body is produced by layering these ceramic green sheets. The recessed portion 113 and a second recessed portion 114 are formed by providing a through hole in the ceramic green sheets by using a mold or the like. Subsequently, the layered body is fired at a temperature of 1300 to 1600° C. to produce the insulating substrate 110.

Regarding dimensions of the insulating substrate 110, for example, the length of one side of the quadrangle is 1 mm to 20 mm, and the thickness of the insulating substrate 110 is 0.5 mm to 5 mm. The dimension of the recessed portion 113 of the insulating substrate 110 can be set in accordance with the size of the battery 200.

As illustrated in FIGS. 2 and 4, a size of the recessed portion 113 in plan view is one size larger than the size of the battery 200 in plan view. An inner wall surface of the recessed portion 113 may be parallel to the thickness direction of the insulating substrate 110. A depth of the recessed portion 113 is greater than the height of the stack of the battery 200 accommodated in the recessed portion 113, the elastic member 140 in a compressed state, and the conductive member 150. A shape of the recessed portion 113 in plan view is not limited to a circular shape, and can be changed in accordance with a shape of the battery 200.

As illustrated in FIGS. 2 to 5, the insulating substrate 110 has the second recessed portion 114 that opens to the inner wall surface of the recessed portion 113. Specifically, as illustrated in FIGS. 2 to 5, the insulating substrate 110 may include two second recessed portions 114. The two second recessed portions 114 may face each other with the recessed portion 113 interposed therebetween. The number of second recessed portions 114 is not limited to two, and a plurality of second recessed portions 114 may be formed along an inner periphery of the recessed portion 113. Alternatively, the second recessed portion 114 may be one recessed portion formed over the entire inner periphery of the recessed portion 113. In other words, the second recessed portion 114 may be a groove formed over the inner periphery of the recessed portion 113.

The insulating substrate 110 includes a fixing portion 115. The fixing portion 115 is a component that limits movement of the conductive member 150 in a direction away from a bottom surface of the recessed portion 113. According to this configuration, the battery 200 accommodated in the recessed portion 113 is interposed between the elastic member 140 and the conductive member 150. In other words, the battery 200 is pressed against the conductive member 150 by the elastic member 140, and the movement of the conductive member 150 is limited by the fixing portion 115. As a result, the battery 200 is fixed in a state of being pressed against the conductive member 150. The elastic member 140 can absorb manufacturing errors such as variations in the height of the battery 200 and variations in the depth of the recessed portion 113, and expansion and contraction of the battery 200. The elastic member 140 can reduce impact when the battery module 500 (500A) is assembled.

In the present embodiment, the insulating substrate 110 includes, for example, a locking portion 115A as the fixing portion 115. The locking portion 115A is a portion of the insulating substrate 110 located above the second recessed portion 114. The locking portion 115A has a locking surface 115a facing the second surface 112. The locking surface 115a can also be said to be an upper surface (ceiling) of the second recessed portion 114. Alternatively, the locking portion 115A may be a protruding portion that protrudes from the inner wall surface of the recessed portion 113 toward the central portion of the recessed portion 113.

The height from the bottom surface of the recessed portion 113 to the locking surface 115a is smaller than the height of the stack of the batteries 200 accommodated in the recessed portion 113, the elastic member 140 in an uncompressed state, and the conductive member 150, and is equal to the height of the stack of the batteries 200, the elastic member 140 in a compressed state, and the conductive member 150.

In the present embodiment, as illustrated in FIGS. 3 to 5, the insulating substrate 110 includes two locking portions 115A. The two locking portions 115A face each other with the recessed portion 113 interposed therebetween. The two locking portions 115A are located at opposing corner portions of the insulating substrate 110. The locking portions 115A are disposed at opposing positions with the recessed portion 113 interposed therebetween, so that the orientation of the conductive member 150 can be stabilized. In addition, the locking portion 115A is located at the corner portion of the insulating substrate 110, so that a region for providing the locking portion 115A can be easily secured and the size of the battery module 500A can be further reduced.

The battery package 100A includes a wiring conductor 130 on and inside the insulating substrate 110. The wiring conductor 130 includes a first electrode 131, second electrodes 132, a first connection wiring 133A, a second connection wiring 133B, a first external electrode 134A, and a second external electrode 134B.

The first electrode 131 is located on the bottom surface of the recessed portion 113, and is electrically connected to the first external electrode 134A by the first connection wire 133A. The first electrode 131 may cover the entire bottom surface of the recessed portion 113. As illustrated in FIG. 4, the first electrode 131 may extend from the bottom surface of the recessed portion 113 to the inside of the insulating substrate 110. When the first electrode 131 extends to the inside of the insulating substrate 110, since the first connection wiring 133A is located at a thick portion of the insulating substrate 110, the strength is excellent. The first electrode 131 may be within the bottom surface of the recessed portion 113 in plan view. That is, the first electrode 131 may not extend to the inside of the insulating substrate 110, and the first connection wiring 133A may be connected to the first external electrode 134A by penetrating from the bottom surface of the recessed portion 113 to the second surface 112. In this case, since a path from the battery 200 to the first external electrode 134A is short and resistance is further reduced, electric power can be efficiently extracted from the battery 200 accommodated in the recessed portion 113.

The second electrode 132 is located on the insulating substrate 110 and is electrically connected to the second external electrode 134B by the second connection wiring 133B. The second electrode 132 may be located on at least one locking surface 115a of the insulating substrate 110. The second electrode 132 may extend from the locking surface 115a to the inside of the insulating substrate 110. The second electrode 132 may cover the entire surface of the locking surface 115a. In the present embodiment, as illustrated in FIGS. 3 and 4, in the insulating substrate 110, the second electrode 132 is located on the locking surface 115a of each of the two locking portions 115A. By providing the plurality of second electrodes 132 in this manner, the probability that at least one second electrode 132 is electrically connected to the conductive member 150 can be improved, so that the reliability of the electrical connection can be improved.

The first external electrode 134A and the second external electrode 134B are located on the second surface 112 of the insulating substrate 110. The first external electrode 134A and the second external electrode 134B may extend from the second surface 112 of the insulating substrate 110 to side surfaces (also including a corner between the side surfaces).

Since both the first external electrode 134A and the second external electrode 134B are each located on the second surface 112 of the insulating substrate 110, the battery package 100A, in other words, the battery module 500A can be surface mounted on a mounting substrate.

The elastic member 140 may be a member having elasticity and conductivity, and may be, for example, a leaf spring or a disc spring located to protrude in a direction away from the bottom surface of the recessed portion 113 as illustrated in FIGS. 2 and 4. The elastic member 140 is located on the first electrode 131, and is located between the first electrode 131 and a lower surface electrode 201 of the battery 200 when one or more batteries 200 are accommodated in the recessed portion 113. The first electrode 131 and the lower surface electrode 201 of the battery 200 accommodated in the recessed portion 113 are electrically connected to each other via the elastic member 140. When the battery 200 is accommodated in the recessed portion 113, the elastic member 140 urges the battery 200 in a direction in which the battery 200 moves away from the bottom surface of the recessed portion 113.

The conductive member 150 is a member for electrically connecting an upper surface electrode 202 of the battery 200 and the second electrode 132. The conductive member 150 may be made of, for example, a metal plate. The conductive member 150 comes into contact with the upper surface electrode 202 of the battery 200 accommodated in the recessed portion 113. When two or more batteries are layered in the vertical direction and accommodated in the recessed portion 113, the conductive member 150 comes into contact with the upper surface electrode 202 of the battery 200 farthest from the bottom surface of the recessed portion 113. The material of the conductive member 150 may be metal. When the conductive member 150 is made of metal, the conductive member 150 having excellent conductivity and durability can be implemented.

As illustrated in FIGS. 2 to 4, the conductive member 150A includes a body portion 151 that comes into contact with the upper surface electrode 202 of the battery 200, and a fixed portion 152 that is fixed to a corresponding locking portion 115A. The body portion 151 may have a shape overlapping or one size smaller than the battery 200 when the battery module 500A is seen through the plan view. When two or more batteries are layered in the vertical direction and accommodated in the recessed portion 113, the body portion 151 comes into contact with the upper surface electrode 202 of the battery 200 farthest from the bottom surface of the recessed portion 113. The fixed portion 152 is a portion extending outward in a radial direction from the body portion 151 in plan view. The fixed portion 152 may extend linearly from the body portion 151 in cross-sectional view. Alternatively, the fixed portion 152 may have a curved portion or a bent portion. In any case, the elastic force of the fixed portion 152 can be set in accordance with the width, thickness, and shape of the fixed portion 152, and the force with which the fixed portion 152 is pressed against the second electrode 132 can be adjusted. In addition, the force with which the body portion 151 is pressed against the upper surface electrode 202 of the battery 200 can be adjusted. As a result, the reliability of the electrical connection between the second electrode 132 and the conductive member 150 and between the battery 200 and the conductive member can be improved.

A height LM of the elastic member 140 in a compressed state can be set in accordance with the depth of the recessed portion 113, the thickness of the locking portion 115A, the thickness of the conductive member 150, the dimension (thickness) of the battery, and the like.

By appropriately setting the height LM of the elastic member 140 in the compressed state, the fixed portion 152 is easily locked to the locking portion 115A. As illustrated in FIG. 4, the height LM of the elastic member 140 in the compressed state is a distance between the lower surface of the battery 200 and the lower surface of a peripheral edge portion (portion in contact with the recessed portion 113) of the elastic member 140. The amount of deformation of the elastic member 140 is a difference between a height in a non-compressed state and a height in a compressed state.

The conductive member 150 is pressed against the locking surface 115a by one or more batteries 200 urged by the elastic member 140, and the upper surface of the conductive member 150 comes into contact with the locking surface 115a of the second electrode 132, so that the second electrode 132 is electrically connected to the upper surface of the conductive member 150. In addition, since the lower surface of the conductive member 150 comes into contact with the upper surface electrode 202 of the battery 200, the conductive member 150 and the battery 200 are electrically connected to each other. Thus, the upper surface electrode of the battery 200 and the second electrode 132 are electrically connected to each other. The conductive member 150 and the upper surface electrode 202 may be bonded to each other by a conductive bonding material, for example. In addition, the conductive member 150 may be integrated with the exterior of the battery 200. When two or more batteries are accommodated in the recessed portion 113, the conductive member 150 may be fixed to the upper surface electrode 202 of the battery 200 farthest from the bottom surface of the recessed portion 113.

The lid 160 may close the opening of the recessed portion 113. The lid 160 is electrically insulated from the first electrode 131 and the second electrode 132. The lid 160 is made of metal. As illustrated in FIGS. 2 and 4, a frame-shaped metal film 122 may be located on the first surface 111, and the lid 160 may be bonded onto the frame-shaped metal film 122. The frame-shaped metal film 122 may be formed on the first surface 111 by metallization. A nickel film may be formed on the surfaces of the frame-shaped metal film 122 and the lid 160 by a plating method in order to improve bondability with a brazing material. As the lid 160 made of metal, a material having a small difference in thermal expansion from ceramic may be used, and for example, an iron-nickel (Fe—Ni) alloy or an iron-nickel-cobalt (Fe—Ni—Co) alloy may be used.

When the opening of the recessed portion 113 is closed by the lid 160, a space S surrounded by the lid 160 and the insulating substrate 110 is hermetically sealed or vacuum sealed. The lid 160 and the frame-shaped metal film 122 may be bonded to each other using a bonding material such as a brazing material. In this case, overall heating is performed by reflow heating. Alternatively, direct seam welding, laser welding, or electron beam welding may be used to bond the lid 160 and the frame-shaped metal film 122. In these welding methods, since bonding is performed by local heating to a bonding portion, hermetic sealing or vacuum sealing can be performed at a lower temperature than in the case of using brazing bonding being bonding by overall heating (reflow heating). By sealing at a low temperature, the influence of heat on the battery 200 is reduced, so that a low dew-point airtight environment or a low dew-point vacuum environment can be implemented.

When a volume obtained by subtracting the volumes of the battery 200, the conductive member 150, and the elastic member 140 located in the space S from the volume of the space S is a gap volume, the ratio of the gap volume to the volume of the space S may be set to, for example, 5% to 30%. The gap amount between the lid 160 and the conductive member 150 may be set to, for example, 0.1 mm to 0.8 mm. These may be set for the battery module 500A in an initial state in which the battery 200 is not expanded and no external force is applied to the lid 160. When the ratio of the gap volume or the gap amount is set in such a manner and thus the battery 200 is expanded or a gas is generated therein with an increase in the temperature of the battery 200, an increase in the internal stress or the internal pressure of the battery 200 is alleviated and the durability of the battery 200 is improved. Even when stress is applied to the lid 160 from the outside, the stress applied to the battery 200 is reduced by a gap between the lid 160 and the conductive member 150.

The space S may be sealed in an atmosphere such as a nitrogen atmosphere, an argon gas atmosphere, or a vacuum at a dew point of-20 °C or less, for example. In this case, even though the environmental temperature and the humidity increase, a chemical reaction between moisture or oxygen and battery materials is suppressed, so that the heat resistance and the life of the battery 200 are improved.

The battery 200 may be a coin cell in which battery materials such as an electrolyte material, a positive electrode, a negative electrode, and a separator are disposed in a metal container and sealed. A coin cell may also be referred to as a button cell. The battery 200 may be a primary battery or a secondary battery. The battery 200 also includes in its category not only a chemical battery but also a power supply element such as an electric double layer capacitor.

The battery 200 includes electrodes (the upper surface electrode 202 and the lower surface electrode 201) on the upper surface and the lower surface thereof. The upper surface electrode 202 of the battery 200 is a positive electrode or a negative electrode. The battery 200 including electrodes on the upper and lower sides thereof is surface mounted on the mounting substrate by accommodating the battery 200 in the battery package 100 of the present disclosure. The internal configuration and materials of the battery 200 are not particularly limited as long as the battery 200 includes electrodes on the upper surface and the lower surface thereof. For example, the battery 200 may be an all-solid-state battery having a structure in which a solid electrolyte is interposed between a positive electrode and a negative electrode. The battery 200 may include current collectors on the outer side of the positive electrode and the negative electrode. The battery 200 may be round or cylindrical, square or prismatic, or any other shape.

Even when the battery 200 is a coin cell that is not surface-mountable alone on the mounting substrate, the battery package 100A enables the coin cell to be surface mounted on the mounting substrate. For example, even when a battery material of the battery 200 is a sulfide-based battery material, the use of an already-sealed coin cell as the batter 200 allows it to be easily sealed even not in a special working environment such as under a dry atmosphere to form the surface-mount type battery 200. The battery 200 can be surface mounted on the mounting substrate even not in a special working environment such as under a dry atmosphere, and the productivity of a circuit board device can be enhanced.

Moreover, the battery 200 can be hermetically sealed at a higher level than a general coin cell by the battery package 100A. In a general coin cell, since a positive electrode and a negative electrode are sealed with a resin material such as a gasket, moisture may enter from the outside over time to deteriorate a battery material. The hermetic sealing by the battery package 100A of the present disclosure can suppress the ingress of moisture to inside the coin cell from the outside. Blocking moisture improves the life of the coin cell. In particular, in a sulfide-based battery, hydrogen sulfide or the like may be generated due to moisture entering from the external environment. By blocking moisture, generation of hydrogen sulfide or the like can be reduced. In the case of the coin cell, since the battery material is doubly sealed with the metal container and the battery package 100A, leakage of the sulfide material from the battery package 100A can be significantly reduced.

As described above, in the battery package 100A according to the first embodiment, since the elastic member 140 is located between the battery 200 and the first electrode 131, the elastic member 140 is not electrically connected to the lid 160 or the like and is not electrically connected to the outside of the battery package 100A. This suppresses discharge to the outside from members other than an external electrode such as the lid 160, so that electric power can be efficiently extracted from the battery 200 via the first external electrode 134A and the second external electrode 134B.

Since the battery package 100A includes the conductive member 150 and the elastic member 140 fixed to the fixing portion, the battery can be fixed without using any conductive resin. Thus, a battery module with high long-term reliability can be implemented. Moreover, by providing the elastic member 140, a variation in the height of the battery or a variation in the depth of the recessed portion of the battery package can be absorbed.

### Another Example of Metallized Pattern on Second Surface

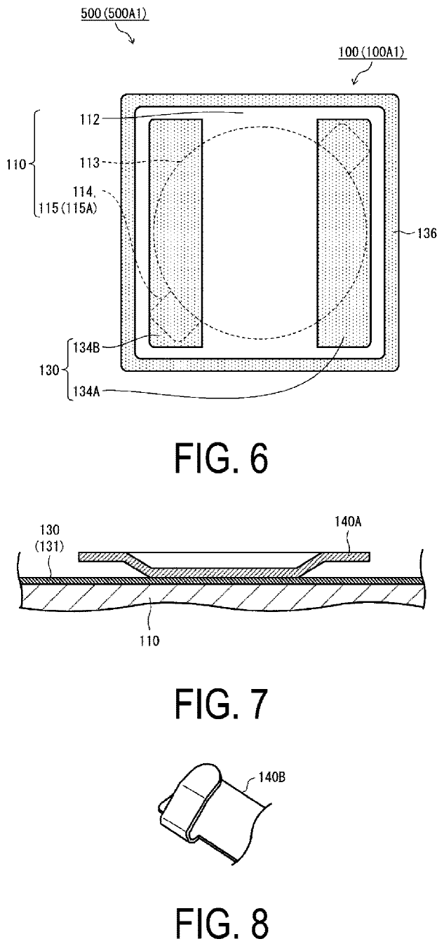

FIG. 6 is a bottom view of the battery package 100A1 in which a seal pattern is formed on the second surface of the insulating substrate.

As in the battery package 100A1 illustrated in FIG. 6, a seal pattern 136 surrounding the periphery of the first external electrode 134A and the second external electrode 134B may be located on the second surface 112 of the insulating substrate 110. The seal pattern 136 is made of a conductive material such as a solderable metal. The seal pattern 136 may surround each of the periphery of the first external electrode 134A and the periphery of the second external electrode 134B.

By bonding the seal pattern 136 and the pattern of the mounting substrate with solder, the first external electrode 134A and the second external electrode 134B located on the inner side of the seal pattern 136 can be sealed. That is, the battery package 100A1 or the battery module 500A1 can be mounted on the substrate so that neither the first external electrode 134A nor the second external electrodes 134B of the battery package 100A1 is exposed to the external environment. Therefore, even though the mounting substrate is flooded with water, no electrical short-circuiting occurs between the first external electrode 134A and the second external electrode 134B and no leakage from the battery module 500A1 occurs. Since the sealing by soldering can be performed simultaneously with the bonding of the first external electrode 134A and the second external electrode 134B with the electrodes of the mounting substrate by soldering.

As illustrated in FIG. 5, when the seal pattern 136 is not located on the second surface 112 of the insulating substrate 110, the peripheral edge portion of the battery module 500A can be sealed with a sealing material such as a resin material. That is, the battery package 100A or the battery module 500A can be mounted on the substrate so that neither the first external electrode 134A nor the second external electrodes 134B of the battery package 100A is exposed to the external environment.

### Another Example of Elastic Member

FIGS. 7, 8, 9, and 10 are diagrams illustrating other examples of the elastic member.

The elastic member 140 is not limited to the example illustrated in FIG. 4, and may be, for example, a leaf spring having another shape, a coil spring formed of a metal wire, conductive rubber, or conductive sponge.

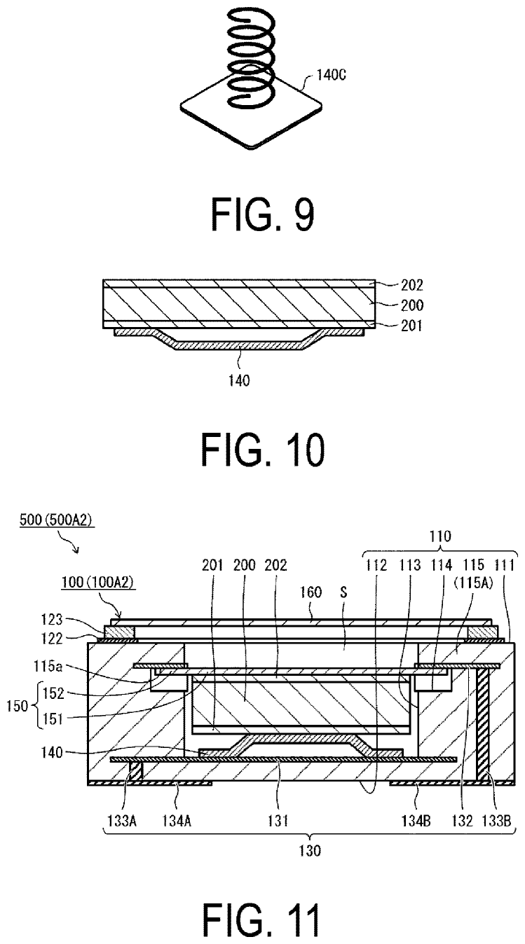

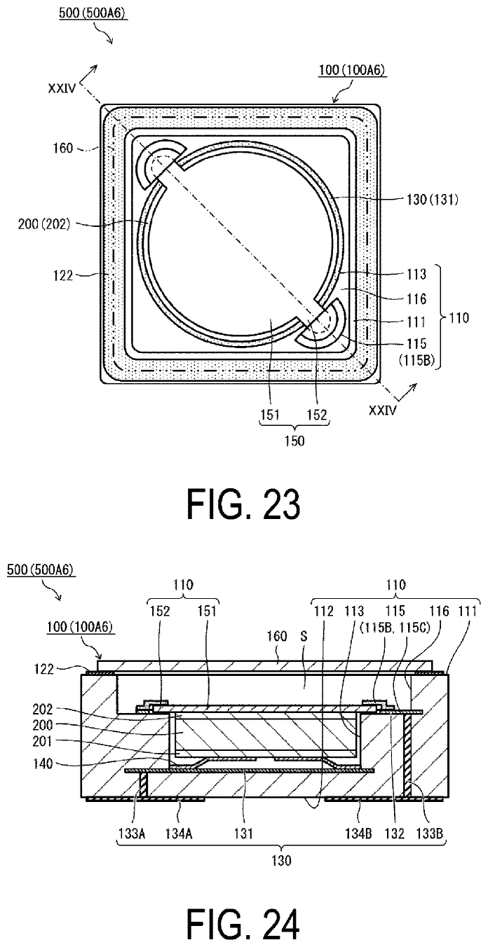

For example, the elastic member 140 may be a leaf spring 140A that protrudes toward the bottom surface of the recessed portion 113 as illustrated in FIG. 7. The leaf spring may be dish-shaped or hat-shaped, and may be provided with through holes or slits. The leaf spring may be a plurality of leaf springs obtained by dividing a hat-shaped spring. Alternatively, the elastic member 140 may include at least one cantilever spring 140B as illustrated in FIG. 8, or may include a plurality of cantilever springs as illustrated in FIG. 24. When the cantilever spring 140B is used, a plurality of cantilever springs may be evenly arranged. Alternatively, the elastic member 140 may be a coil spring 140C as illustrated in FIG. 9.

As illustrated in FIG. 10, the elastic member 140 may be a leaf spring or a disc spring that protrudes toward the bottom surface of the recessed portion 113 from the lower surface electrode 201 of the battery 200. The elastic member 140 may be fixed to the lower surface electrode 201 of the battery 200 and integrated with the exterior of the battery 200. When two or more batteries are accommodated in the recessed portion 113, the elastic member 140 may be fixed to the lower surface electrode 201 of the battery 200 closest to the bottom surface of the recessed portion 113.

Alternatively, the elastic member 140 may be conductive rubber or conductive sponge. By using graphene mesosponge (GMS) as the conductive sponge, the elastic member 140 having excellent conductivity and durability can be implemented.

### Example with Metal Frame Body

FIG. 11 is a cross-sectional view of the battery module 500A2 including the battery package 100A2 having a metal frame body.

As illustrated in FIG. 11, the battery package 100A2 may have a metal frame body 123 located above the first surface 111. In this case, the metal frame body 123 may be bonded onto the frame-shaped metal film 122 by a brazing material, and the lid 160 may be bonded to the metal frame body 123. For example, seam welding, direct seam welding, laser welding, or electron beam welding is used to bond the metal frame body 123 and the lid 160. In particular, the seam welding is resistance welding via the metal frame body 123, and is advantageous in local heating of a bonding portion. Current is applied to the lid 160 at the time of seam welding, but since the lid 160 is not electrically connected to the battery 200, the battery 200 is not damaged by the current at the time of seam welding. Moreover, since the conductive member 150 is located between the lid 160 and the battery 200, the influence on the battery 200 by radiant heat from the lid 160 generated at the time of welding is also reduced.

A nickel film may be formed on the surface of the metal frame body 123 by a plating method in order to improve bondability with a brazing material. As the metal frame body 123, a material having a small difference in thermal expansion from ceramic may be used, and for example, an iron-nickel (Fe—Ni) alloy or an iron-nickel-cobalt (Fe—Ni—Co) alloy may be used.

### Another Example of Locking Portion

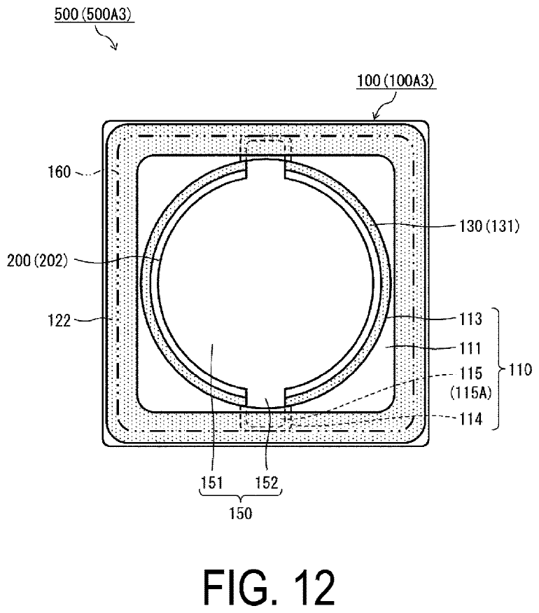

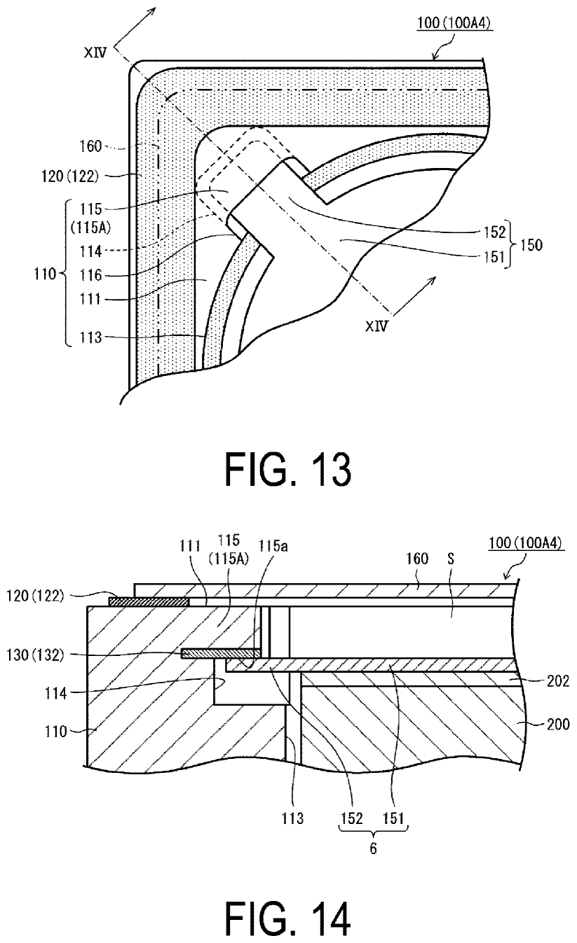

FIGS. 12 and 13 are plan views of the battery package 100A3 and the battery package 100A4, respectively, each having a locking portion of an aspect different from that of the battery package 100A illustrated in FIGS. 1 to 5. FIGS. 12 and 13 are plan views illustrating other states of the locking portion included in the insulating substrate. FIG. 14 is a cross-sectional view taken along line XIV in FIG. 13.

The direction of a line connecting the two opposing locking portions 115A may be any direction. For example, as in the battery package 100A3 illustrated in FIG. 12, the locking portion 115A may be located not at the corner portion but at a side portion of the insulating substrate 110.

As illustrated in FIGS. 13 and 14, the second recessed portion 114 may be opened to the first surface 111 as if a notch is formed from the recessed portion 113. In other words, the end portion of the upper surface of the second recessed portion 114 is located outside the end portion of the lower surface thereof in plan view. In other words, an inner surface of the locking portion 115A is located outside the inner wall surface of the recessed portion 113.

The opening of the second recessed portion 114 guides the insertion of the fixed portion 152 into the second recessed portion 114 and facilitates the engagement between the fixed portion 152 and the locking portion 115A.

### Configuration for facilitating Insertion of Conductive Member 150

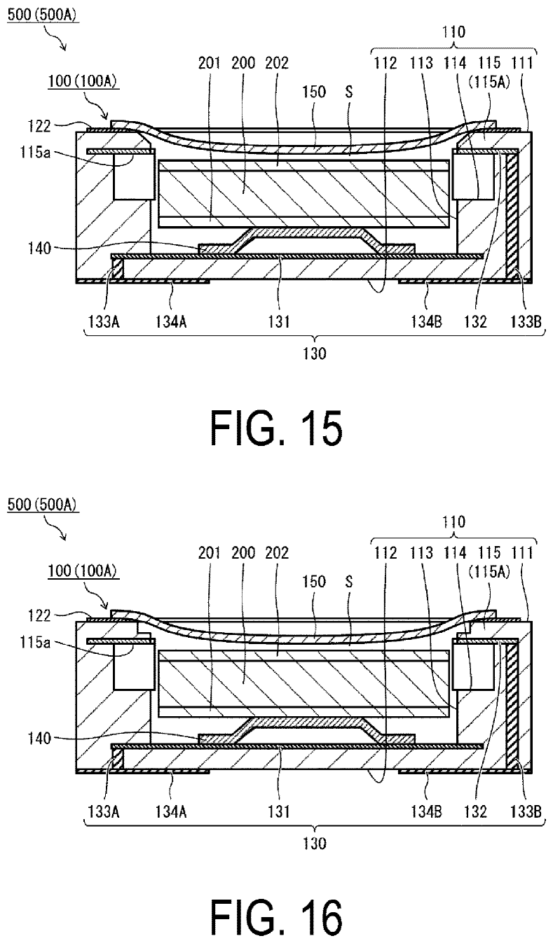

FIG. 15 is a cross-sectional view illustrating a state of assembling the battery module 500A of FIG. 1 having an inclined surface on the locking portion 115A. FIG. 16 is a cross-sectional view illustrating a state of assembling the battery module 500A of FIG. 1 having a stepped surface on the locking portion 115A.

As illustrated in FIGS. 15 and 16, in a process of assembling the battery module 500A, the conductive member 150 is inserted into the recessed portion 113 by being pushed into the recessed portion 113 so as to be deformed to protrude downward. As illustrated in FIGS. 15 and 16, the upper surface of the locking portion 115A may be a stepped surface or an inclined surface that approaches the central portion of the recessed portion 113. In other words, the amount of protrusion of the locking portion 115A may gradually increase from the first surface 111 side toward the second surface 112 side. The inclination angle of the inclined surface approximating the stepped surface or the inclination angle of the inclined surface may be in a range of 1° to 45° with respect to the thickness direction of insulating substrate 110. The number of steps of the stepped surface may be one or two or more. even though a dimensional error exists in one or both of the insulating substrate 110 and the conductive member 150, the fixed portion 152 of the conductive member 150 can be smoothly inserted into the second recessed portion 114 due to the stepped shape or the inclined surface.

The conductive member 150 may have a material and/or a shape that is easily deformed to protrude downward. This facilitates the insertion of the conductive member 150 into the recessed portion 113. In addition, the conductive member 150 may have a material and/or a shape that is difficult to be deformed to protrude upward. Accordingly, the engagement between the fixed portion 152 of the conductive member 150 and the locking portion 115A is less likely to be released.

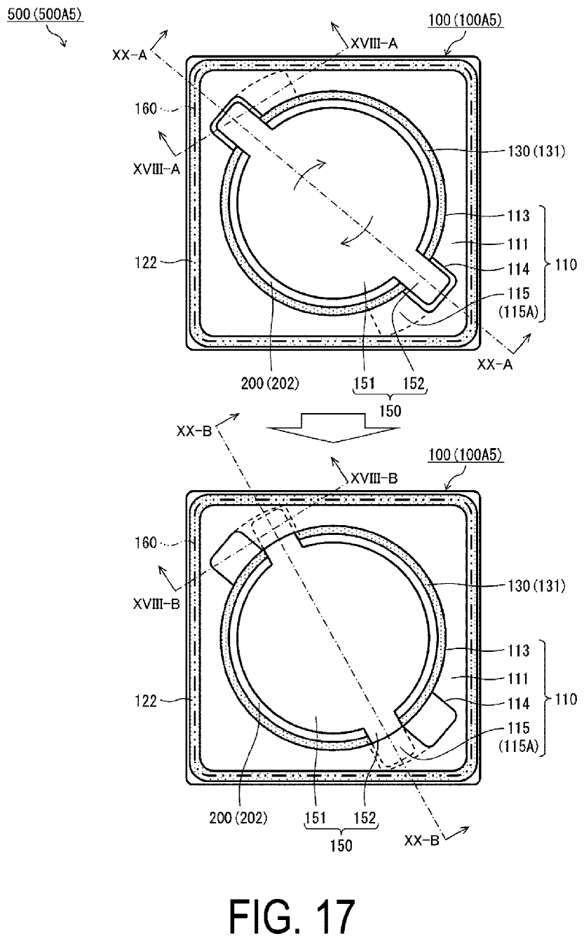

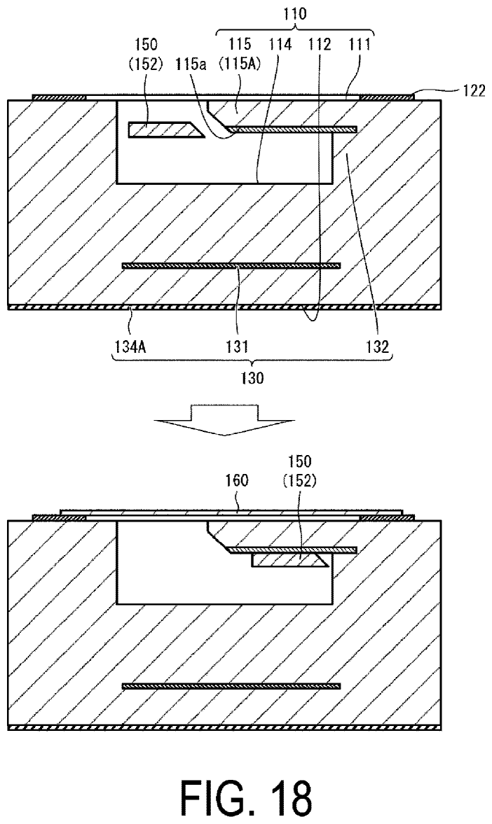

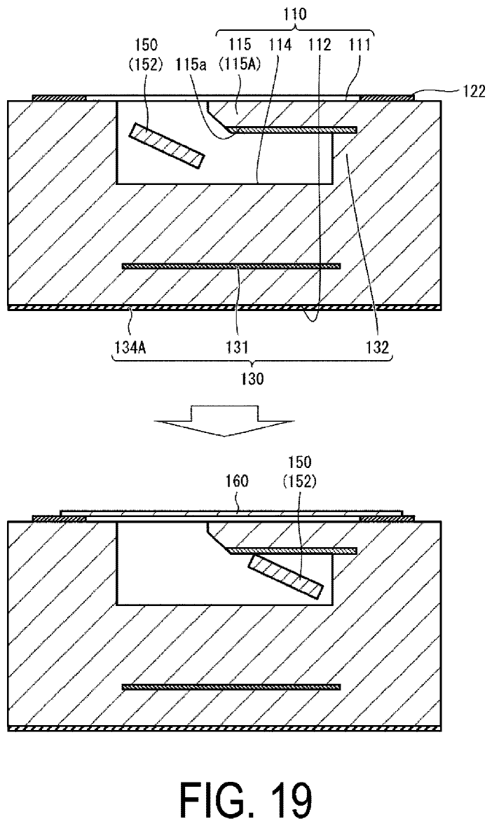

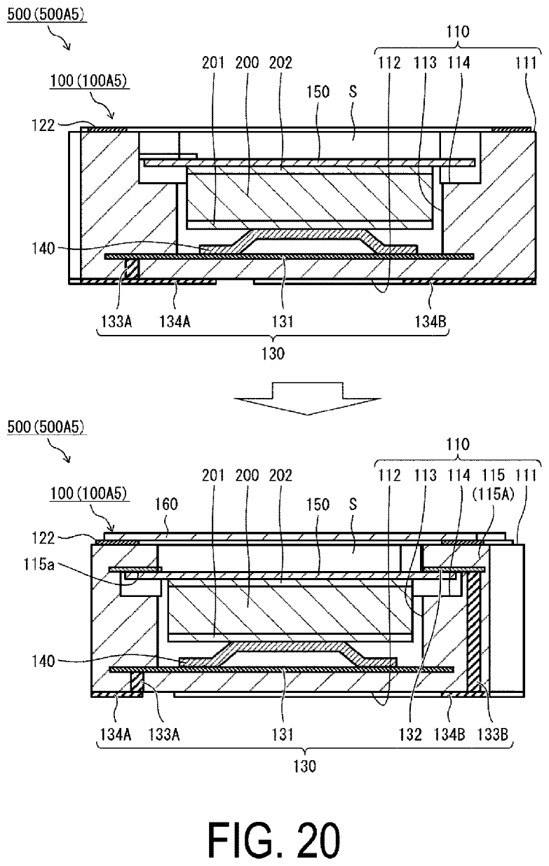

FIG. 17 is a plan view illustrating a state of assembling the battery module 500A5. The insulating substrate 110 of the battery module 500A5 opens to the first surface 111 and the recessed portion 113 on the side of the locking portion 115A. In other words, the second recessed portion 114 of the battery module 500A5 opens to the first surface 111 on the side of the locking portion 115A. FIG. 18 is a cross-sectional view taken along lines XVIII-A and XVIII-B in FIG. 17. FIG. 19 is a cross-sectional view illustrating another example of engagement between the fixed portion and the locking portion. FIG. 20 is a cross-sectional view taken along lines XX-A and XX-B in FIG. 17.

As illustrated in FIGS. 17 and 18, the second recessed portion 114 of the battery package 100A5 may open to the recessed portion 113 below the locking portion 115A, and may open to the first surface 111 and the recessed portion 113 on the side of the locking portion 115A. This configuration can guide the insertion of the fixed portion 152 into the second recessed portion 114 and below the locking portion 115A and easily fix the conductive member 150.

As illustrated in FIGS. 17 and 20, the fixed portion 152 and the body portion 151 are first inserted into the second recessed portion 114 and the recessed portion 113, respectively, through the opening of the first surface 111. Subsequently, by rotating the conductive member 150, the fixed portion 152 is moved below the locking portion 115A. Irregularities or protrusions may be located on the upper surface of the body portion 151 in order to facilitate the rotation of the conductive member 150.

As illustrated in FIG. 18, a corner on the front side in the rotation direction of the fixed portion 152 may be chamfered so that the fixed portion 152 easily moves below the locking portion 115A. A corner of the locking portion 115A facing the fixed portion 152 may be chamfered so that the fixed portion 152 easily moves below the locking portion 115A. As illustrated in FIG. 19, in order for the fixed portion 152 to easily move below the locking portion 115A, the whole or the tip of the fixed portion 152 may form an angle with the body portion 151 so that the front side in the rotation direction is lowered. The configuration in which the fixed portion 152 forms an angle with the body portion 151 can further reduce the possibility that the fixed portion 152 having once entered below the locking portion 115A due to rotation returns. A surface of the fixed portion 152 in contact with the insulating substrate 110 may be rough so that the conductive member 150 is less likely to rotate in the reverse direction due to vibration of the battery package 100 (100A).

### Another Example of Battery

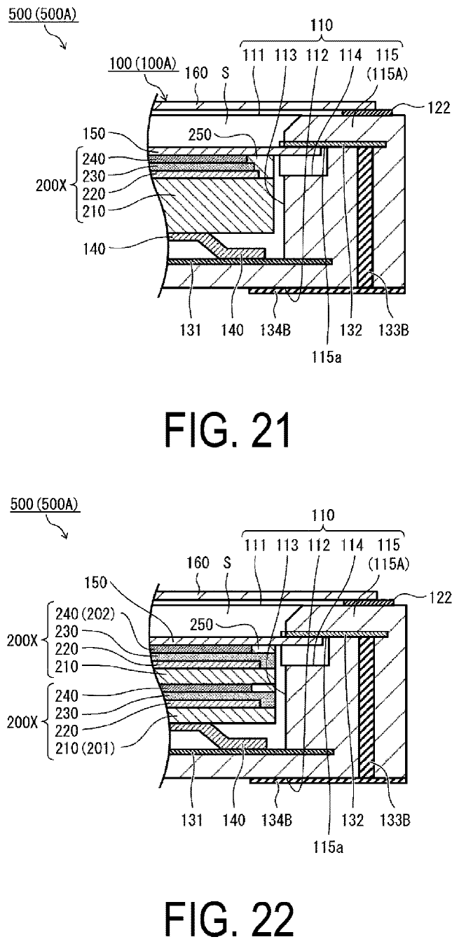

FIG. 21 is a partially enlarged cross-sectional view of the battery module 500A using a battery 200X being a thin-film type all-solid-state battery as a battery. FIG. 22 is a partially enlarged cross-sectional view of the battery module 500A using batteries 200X being a plurality of thin-film type all-solid-state batteries as batteries.

As illustrated in FIG. 21, the battery module 500A may include the battery 200X being the thin-film type all-solid-state battery. The battery 200X has a configuration in which a negative electrode layer 220, an electrolyte layer 230, and a positive electrode layer 240 are layered on a metal plate 210, and the metal plate 210 functions as a current collector. The metal plate 210 is, for example, a plate made of copper, aluminum, stainless steel, or the like, and has a plate thickness of, for example, 0.1 mm to 0.5 mm. The negative electrode layer 220, the electrolyte layer 230, and the positive electrode layer 240 are formed by, for example, a vapor deposition method, a sputtering method, or the like. The battery 200X may include a resin cover 250 that covers an end face of the negative electrode layer 220, an end face of the electrolyte layer 230, and an end face of the positive electrode layer 240, and the resin cover 250 is made of an insulating resin. The battery module 500A may include a non-thin-film type all-solid-state battery.

In the case of the battery package 100A of the example illustrated in FIG. 21, the metal plate 210 corresponds to the lower surface electrode 201, and the positive electrode layer 240 corresponds to the upper surface electrode 202. The negative electrode layer 220, the electrolyte layer 230, and the positive electrode layer 240 are sequentially layered from the lower metal plate 210; however, the negative electrode layer 220 and the positive electrode layer 240 may be reversely layered. In such a case, the negative electrode layer 220 corresponds to the upper surface electrode 202.

The position of the end face of the negative electrode layer 220, the position of the end face of the electrolyte layer 230, and the position of the end face of the positive electrode layer 240 may be displaced. For example, the negative electrode layer 220, the electrolyte layer 230, and the positive electrode layer 240 may be made smaller or larger in the layering order. The electrolyte layer 230 may be larger than the positive electrode layer 240 and the negative electrode layer 220. In this case, the possibility of short-circuiting between the positive electrode layer 240 and the negative electrode layer 220 in the side surface direction can be reduced.

As illustrated in FIG. 22, the battery module 500A may include the plurality of batteries 200X. The plurality of batteries 200X may be accommodated in series in the recessed portion 113 of the battery package 100 so as to be layered in the vertical direction. A conductive bonding material may be interposed between the plurality of batteries 200X. The end portion of the electrolyte layer 230 may cover the end portion of the negative electrode layer 220. The plurality of batteries 200X are efficiently manufactured by forming a thin film battery on a large metal plate and dividing the thin film battery into pieces with a predetermined size. The plurality of batteries 200X may be connected by contact without the intervention of a bonding material. By interposing and pressing the plurality of batteries 200X between the elastic member 140 and the conductive member 150, the contact resistance between the plurality of batteries 200X can be reduced.

In general, a thin-film all-solid-state battery has high energy density, high safety, and excellent recycle life. In addition, as described above, when the battery module 500 uses the battery 200X having the metal plate 210, mass production of the battery 200X becomes possible and productivity of the battery module 500A is improved. Specifically, after the negative electrode layer 220, the electrolyte layer 230, and the positive electrode layer 240 are formed on the metal plate 210, the battery 200X having a size that matches the recessed portion 113 of the insulating substrate 110 is cut out by dicing or the like and placed in the recessed portion 113 of the insulating substrate 110. Thus, the productivity of the battery module 500A is improved.

When the battery module 500A uses the battery 200X having the metal plate 210, the adhesion between the metal plate 210 and the negative electrode layer 220, the adhesion between the negative electrode layer 220 and the electrolyte layer 230, and the adhesion between the positive electrode layer 240 and the electrolyte layer 230 are increased. Therefore, the power extraction efficiency of the battery 200X is increased.

### Another Example of Fixing Portion

An example in which the fixing portion 115 is a locking fitting or a fixing metal film fixed or bonded to the insulating substrate 110 is described below.

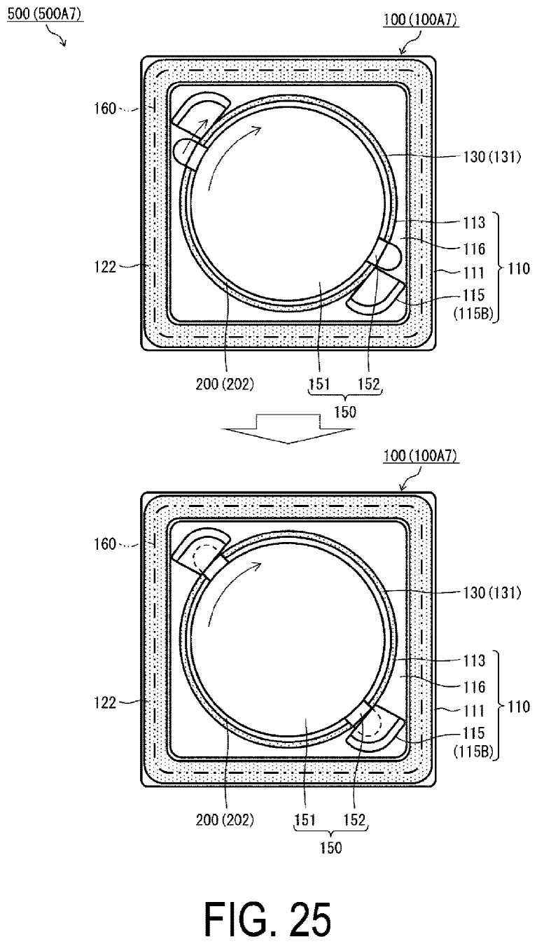

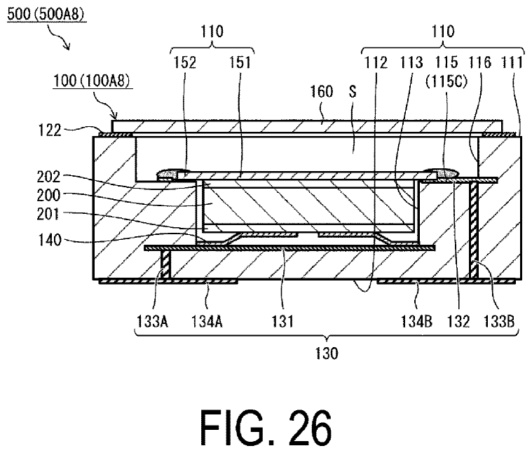

FIG. 23 is a plan view of the battery module 500A6 in a state in which the lid is removed. FIG. 24 is a cross-sectional view taken along line XXIV in FIG. 23. FIG. 25 is a plan view of the battery module 500A7 in a state in which the lid is removed. FIG. 26 is a cross-sectional view of the battery module 500A8.

As illustrated in FIGS. 23 and 24, the insulating substrate 110 may include, as the fixing portion 115, for example, a locking fitting 115B fixed or bonded to the insulating substrate 110. Compared with the insulating substrate 110 including the second recessed portion 114, the insulating substrate 110 including the locking fitting 115B is easy to manufacture. Moreover, the strength of the insulating substrate 110 can be improved, and the strength of the fixing portion 115 can be improved. The insulating substrate 110 may include a notch 116 (see FIG. 24) that opens to the first surface 110 and the recessed portion 113 so that the locking fitting 115B and the conductive member 150 are less likely to come into contact with the lid 160, and the locking fitting 115B may be bonded onto a bottom surface of the notch 116. A depth of the notch 116 may be made greater than a height of the locking fitting 115B so that the locking fitting 115B and the conductive member 150 are less likely to come into contact with the lid 160. When the depth of the notch 116 is equal to or smaller than the height of the locking fitting 115B, the metal frame body 123 and/or an insulating frame body made of a ceramic material may be located between the insulating substrate 110 and the lid 160. In FIG. 23, the bottom surface of the notch 116 can be regarded as the first surface 110, and a portion of the insulating substrate 110 rising outside the notch 116 can be regarded as the insulating frame body. That is, the insulating substrate 110 may include the locking fitting 115B on the first surface 110 and an insulating frame body outside the locking fitting 115B.

The locking fitting 115B may be fixed to the insulating substrate 110 in a state in which the conductive member 150 is pressed against the battery 200. The locking fitting 115B may be bonded to a fixing metal film 115C on the insulating substrate 110. The fixing metal film 115C may also serve as the second electrode 132 (see FIG. 26).

As illustrated in FIG. 25, the locking fitting 115B may open laterally to the recessed portion 113. By the rotation of the conductive member 150, the fixed portion 152 is inserted into the locking fitting 115B from the side opening of the locking fitting 115B.

As illustrated in FIG. 26, the insulating substrate 110 may include, for example, the fixing metal film 115C as the fixing portion 115. The fixed portion 152 may be bonded to the fixing metal film 115C by metal welding such as brazing, soldering, or laser irradiation. The insulating substrate 110 including the fixing metal film 115C is manufactured more easily than the insulating substrate 110 including the second recessed portion 114. Moreover, the strength of the insulating substrate 110 can be improved, and the strength of the fixing portion 115 can be improved. The fixing metal films 115C may also serve as the second electrodes 132. The fixing metal film 115C may be located on the bottom surface of the notch 116 so that the conductive member 150 is less likely to come into contact with the lid 160. A frame body may be located between the insulating substrate 110 and the lid 160 so that the conductive member 150 is less likely to come into contact with the lid 160.

### Another Example of Conductive Member 150

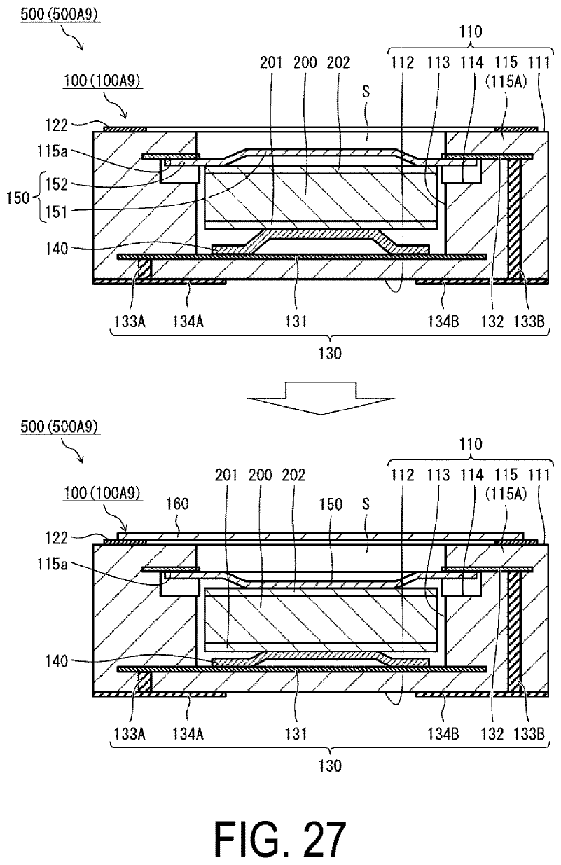

FIG. 27 is a cross-sectional view of the battery module 500A9 in which the conductive member is invertible. As illustrated in FIG. 27, the conductive member 150 may be an invertible leaf spring having a protruding portion for pressing the battery 200 from above by vertical inversion at a central portion of the conductive member 150. The upper part of FIG. 27 is a cross-sectional view illustrating a state before the conductive member 150 is inverted, and the lower part of FIG. 27 is a cross-sectional view illustrating a state after the conductive member 150 is inverted. The conductive member 150 may have an upwardly protruding shape and may be inserted into the second recessed portion 114 and the recessed portion 113. The conductive member 150 may have an upwardly protruding shape before the fixed portion 152 is inserted into the second recessed portion 114. The conductive member 150 may be inverted into a downwardly protruding shape during or after insertion. The battery is pressed downward by the body portion 151 of the conductive member 150 having a downwardly protruding shape, and the elastic member 140 is compressed. The battery 200 is pressed against the conductive member 150 by the compressed elastic member 140, so that the movement of the conductive member 150 is limited by the fixing portion 115 and the battery 200 is fixed. The thickness of the conductive member 150 or the invertible protruding portion of the conductive member 150 in the central portion thereof allows the battery package 100A9 to accommodate various thicknesses and numbers of batteries 200.

In the configuration in which the conductive member 150 is rotated as described above with reference to FIGS. 17 to 20, while the conductive member 150 is rotated, the fixed portion 152 does not come into contact with the locking surface 115a due to the conductive member 150 having an upwardly protruding shape, and the conductive member 150 is easily rotated. After the conductive member 150 is located below the locking portion 115A, the conductive member 150 is inverted into a downwardly protruding shape, so that the fixed portion 152 can come into contact with the locking surface 115a. By this contact, the fixed portion 152 is electrically connected to the second electrode 132.

### Second Embodiment

Another embodiment of the present disclosure is described below. For convenience of description, members having the same functions as those of the members described in the above embodiment are denoted by the same reference signs, and description thereof is not repeated. Battery modules 500B and 500B2 to 500B6 to be described in the second embodiment are examples of the battery module 500 according to the present disclosure. Battery packages 100B and 100B2 to 100B6 to be described in the second embodiment are examples of the battery package 100 according to the present disclosure.

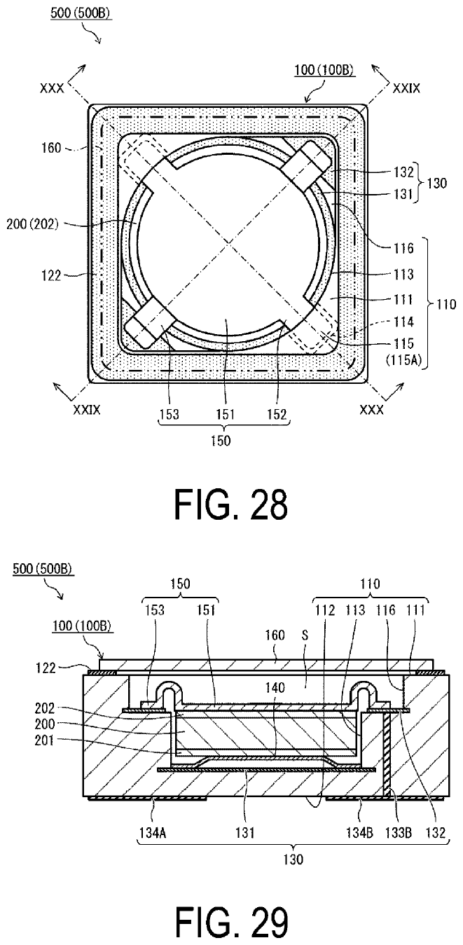

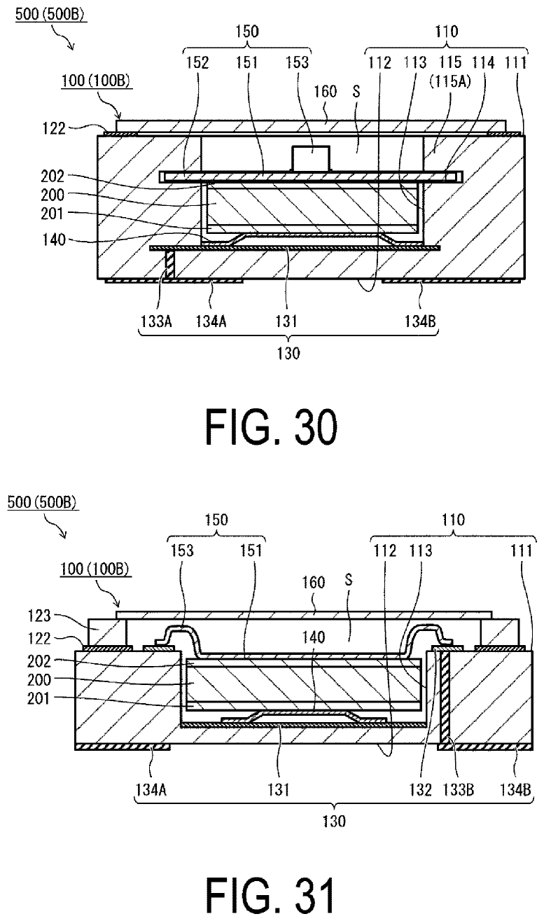

FIG. 28 is a plan view illustrating the battery module 500B in a state in which a lid is removed. FIG. 29 is a cross-sectional view taken along line XXIX in FIG. 28. FIG. 30 is a cross-sectional view taken along line XXX in FIG. 28.

As illustrated in FIGS. 28 to 30, in the battery package 100B according to the present embodiment, the conductive member 150 includes a body portion 151, a connection portion 153, and a fixed portion 152. The body portion 151 is a portion that comes into contact with the upper surface electrode 202 of the battery 200. The connection portion 153 is a portion electrically connected to a corresponding second electrode 132. The fixed portion 152 is a portion fixed to a corresponding fixing portion 115. When the fixing portion 115 is the locking portion 115A, the fixed portion 152 is a portion to be locked by the locking portion 115A.

The conductive member 150 may include only one connection portion 153, or may include two or more connection portions. The reliability of the electrical connection between the second electrode 132 and the conductive member 150 can be improved by the two or more connection portions 153. The conductive member 150 may include two or more fixed portions 152. The center of a force pressing the battery 200 may be located on a line segment connecting the two or more fixed portions 152 or within a polygon. The two fixed portions 152 may be diagonally located on the insulating substrate 110.

Each of the connection portion 153 and the fixed portion 152 extends radially outward from the body portion 151 in plan view. The elastic force of the connection portion 153 can be set in accordance with the width, thickness, and shape of the connection portion 153, and the force with which the connection portion 153 is pressed against the second electrode 132 can be adjusted. The elastic force of the fixed portion 152 can be set in accordance with the width, thickness, and shape of the fixed portion 152, and the force with which the body portion 151 is pressed against the upper surface electrode 202 of the battery 200 can be adjusted. As a result, the reliability of the electrical connection between the second electrode 132 and the conductive member 150 and between the battery 200 and the conductive member can be improved.

The extending direction of the connection portion 153 may be different from any extending direction of the fixed portion 152 in plan view. The extending direction of the connection portion 153 forms an angle with the extending direction of the closest fixed portion 152 in plan view. “Forming an angle” means that the angle between the two directions is greater than 0°. Since the connection portion 153 and the fixed portion 152 are located in different directions with respect to the center of the recessed portion 113 in plan view, the second electrode 132 is disposed in a direction different from that of the locking portions 115A. When the insulating substrate 110 has a rectangular shape in plan view and the battery 200 has a circular shape in plan view, the fixing portion 115 and the second electrode can be disposed at non-overlapping positions in perspective plan view.

FIGS. 28 to 30 illustrate an example in which a line connecting two opposing connection portions 153 and a line connecting two opposing fixed portions 152 intersect each other to form an angle. In this case, two fixing portions 115 and two second electrodes 132 can be disposed at four corners of the insulating substrate 110 in plan view. When the insulating substrate 110 is substantially square in plan view, a crossing angle is about 90°. This makes it possible to reduce the size of the battery package 100B. In the battery package 100B, the insulating substrate 110 may have notches 116 that open to the first surface 111 and the recessed portion 113, and the second electrodes 132 may be located on the bottom surfaces of the notches 116

As illustrated in FIG. 28, the battery package 100 (100B) may include a plurality of second electrodes 132 and a plurality of locking portions 115A. In such a case, in plan view, two second electrodes 132 may be located at opposing positions with the recessed portion 113 interposed therebetween, and two locking portions 115A may be located at opposing positions with the recessed portion 113 interposed therebetween. Moreover, a line connecting the two second electrodes 132 and a line connecting the two locking portions 115A may form an angle. Such an arrangement of the second electrodes 132 and the locking portions 115A stabilizes the pressing and fixing by the elastic member 140 and the conductive member 150. Even though the elastic member 140 is rotated and twisted about the line connecting the opposing locking portions 115A, at least one of the two connection portions 153 comes into contact with the second electrode 132. When the battery package 100 (100B) includes three or more locking portions 115A, the three or more locking portions 115A may be located line-symmetrically or rotationally symmetrically to surround the recessed portion 113.

Each of the connection portion 153 and the fixed portion 152 may extend linearly from the body portion 151 in cross-sectional view, or may have a curved portion or a bent portion between a connection portion with the body portion 151 and an end portion. In FIG. 29, the connection portion 153 includes a U-shaped curved portion that protrudes upward (toward the lid 160) and a flat plate portion that comes into contact with the second electrode 132.

FIGS. 31, 32 and 33 are cross-sectional views of the battery module 500B taken along line XXIX in FIG. 28, and illustrate examples in which the connection portion 153 of the conductive member 150 has other shapes. In FIG. 31, the connection portion 153 has a protruding portion that protrudes toward the lid 160 and a flat plate portion that comes into contact with the second electrode 132.

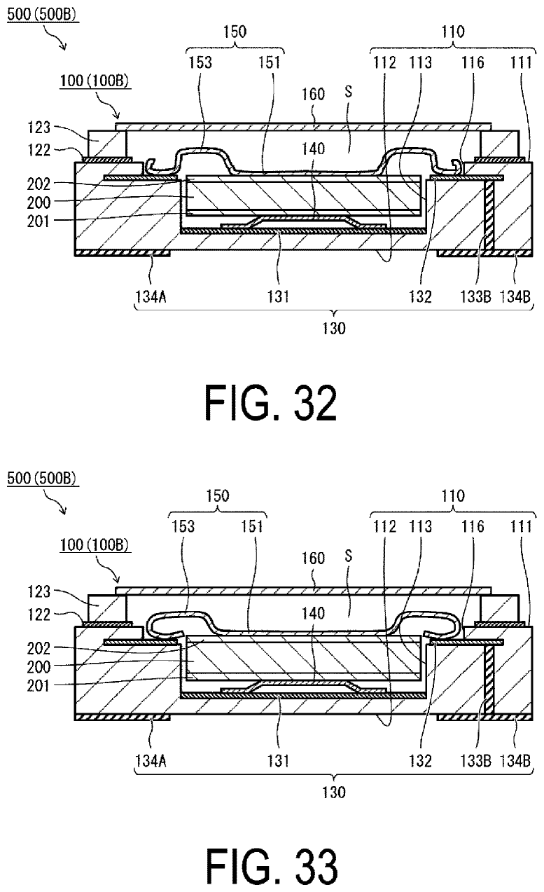

In FIG. 32, the connection portion 153 includes a protruding portion that protrudes toward the lid 160, a flat plate portion that comes into contact with the second electrode 132, and an end portion that is curved (rounded) upward. In FIG. 33, the connection portion 153 includes a protruding portion that protrudes toward the lid 160 and an end portion that is curved downward. Since the end portion is curved, even though the connection portion 153 comes into contact with the insulating substrate 110, the conductive member 150 can be smoothly inserted into the recessed portion 113.

As illustrated in FIGS. 29, 31, 32, and 33, since the connection portion 153 includes a curved portion or a bent portion, an elastic force is easily adjusted in accordance with the width and the shape of the connection portion 153. A force with which the connection portion 153 comes into contact with the second electrode 132, or the like is easily adjusted by the shape of the curved portion or the bent portion. Since the connection portion 153 includes the curved portion or the bent portion, the connection portion 153 can have elasticity in a direction traversing the body portion 151, that is, in a radial direction. Moreover, the connection portion 153 may have elasticity in the thickness direction of the body portion 151. The elasticity can absorb a dimensional error in the thickness direction during manufacturing and an impact during assembly.

Since the connection portion 153 has the curved portion or the bent portion, a change in the thickness of the battery 200 with respect to the thickness of the battery package 100, the depth of the recessed portion 113, the height from the bottom surface of the recessed portion 113 to the locking surface 115a, or the like can be coped with. That is, by using the conductive member 150 having the curved portion or the bent portion, one insulating substrate 110 and one elastic member 140 can cope with batteries having different thicknesses. As a specific example, by changing the bending direction of the bent portion, the range of the thickness of the battery 200 that can be accommodated can be changed. For example, when the bent portion is bent upward, a thin battery can be coped with, and when the bent portion is bent downward, a thick battery can be coped with.

As illustrated in FIGS. 28, 29, 32, and 33, the insulating substrate 110 may have the notch 116 that opens to the first surface 111 and the recessed portion 113, and the second electrode 132 may be located on the bottom surface of the notch 116. Alternatively, as illustrated in FIG. 31, the second electrode 132 may be located on the first surface 111. In either case, the second electrode 132 is exposed on an upward surface. The second electrode 132 comes into contact with and is electrically connected to the lower surface of the connection portion 153 of the conductive member 150.

With this configuration, the external appearance of the second electrode 132 and the connection between the conductive member 150 and the second electrode 132 can be visually checked. In addition, when the second electrode 132 is located on the first surface 111, the second electrode 132 and the frame-shaped metal film 122 can be formed in the same process. For example, the second electrode 132 and the frame-shaped metal film 122 can be formed in the same process by a screen-printing method.

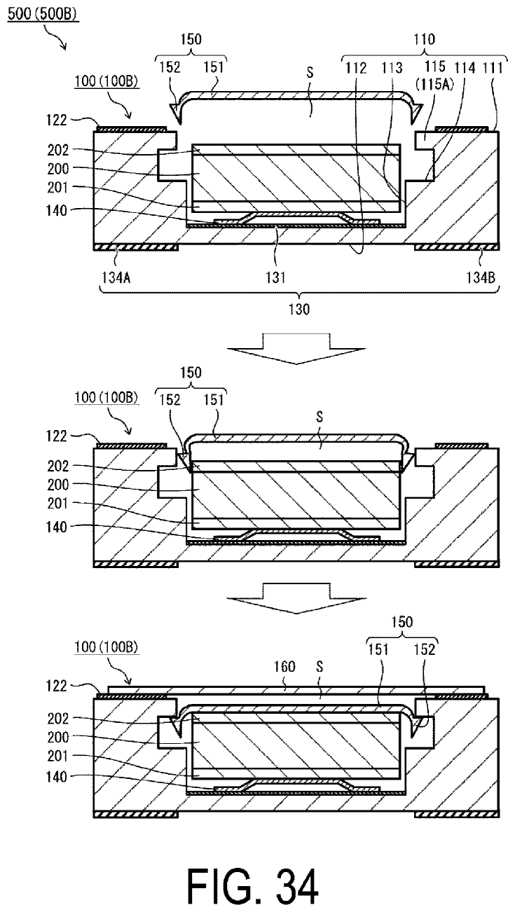

FIGS. 34, 35 and 36 are cross-sectional views of the battery module 500B taken along line XXVIII in FIG. 28 and illustrate examples in which the fixed portion 152 of the conductive member 150 has other shapes. In FIGS. 34 to 36, the conductive member 150 includes a bent portion that is bent downward at the boundary between the body portion 151 and the fixed portion 152 or at the fixed portion 152.

As illustrated in FIGS. 34, 35, and 36, the conductive member 150 may have a curved portion or a bent portion at the fixed portion 152, and may have elasticity in a direction traversing the body portion 151, that is, in a radial direction. As illustrated in FIG. 34, the fixed portion 152 is deformed to contract in the radial direction, and the conductive member 150 is easily inserted into the recessed portion 113. After the insertion, the fixed portion 152 returns to expand in the radial direction, and the fixed portion 152 is locked to the locking portion 115A.

The conductive member 150 is less likely to be displaced in the radial direction.

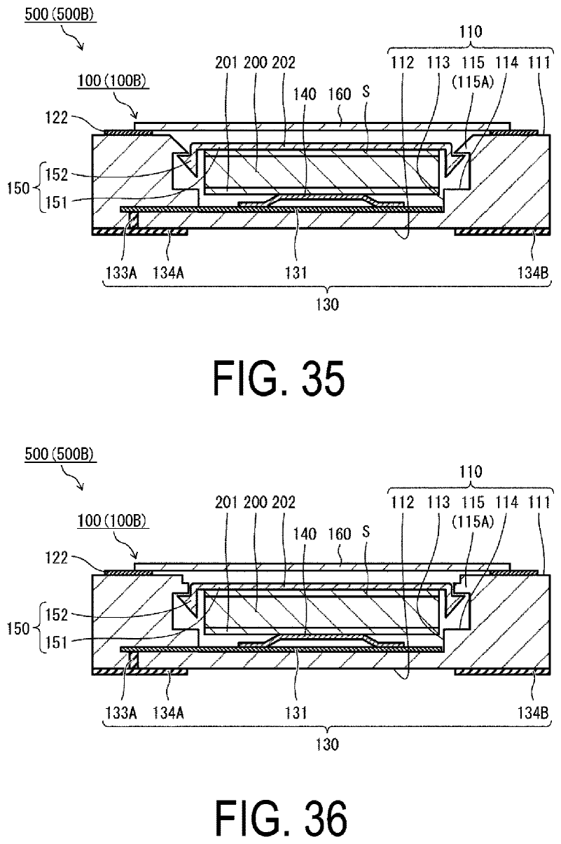

As illustrated in FIGS. 35 and 36, the upper surface of the locking portion 115A may be a stepped surface or an inclined surface that approaches the central portion of the recessed portion 113. In other words, the amount of protrusion of the locking portion 115A increases stepwise or gradually from the first surface 111 side toward the second surface 112 side. The inclination angle of the inclined surface approximating the stepped surface or the inclination angle of the inclined surface may be in a range of 1°to 45° with respect to the thickness direction of the insulating substrate 110. With this configuration, the fixed portion 152 of the conductive member 150 can be easily inserted below the locking portion 115A.

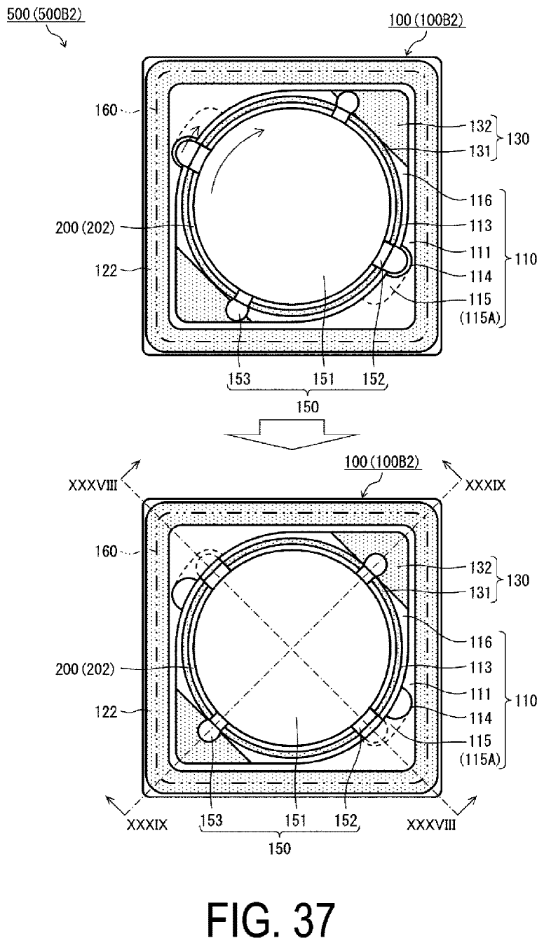

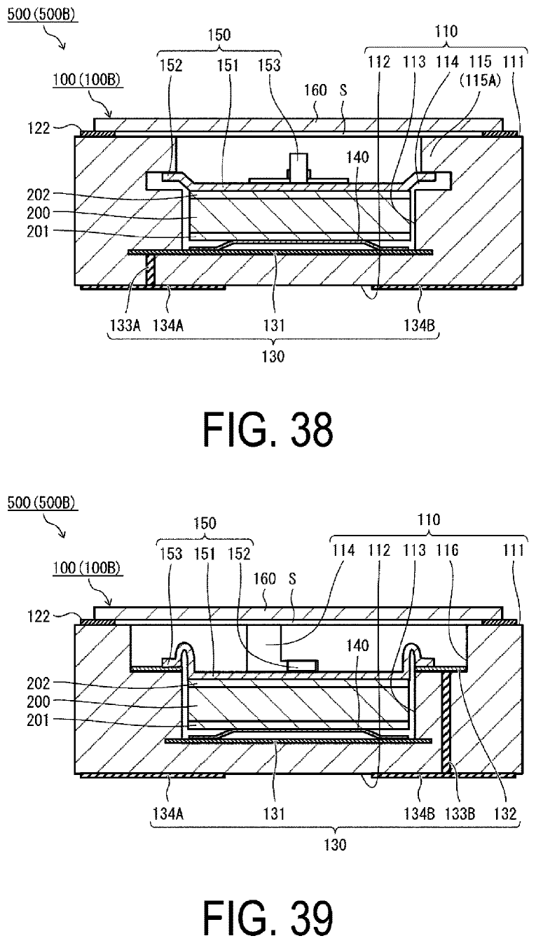

FIG. 37 is a plan view illustrating a state of assembling the battery module 500B2. In the battery package 100B2 of the battery module 500B2, the insulating substrate 110 opens to the first surface 111 and the recessed portion 113 on the side of the locking portion 115A. FIG. 38 is a cross-sectional view taken along line XXXVIII in FIG. 37. FIG. 39 is a cross-sectional view

### Taken Along Line XXXIV in FIG. 37.

As illustrated in FIGS. 37 to 39, in the assembly process of the battery module 500B2, the fixed portion 152 and the body portion 151 are inserted into the second recessed portion 114 and the recessed portion 113, respectively, from the opening of the first surface 111. Subsequently, by the rotation of the conductive member 150, the fixed portion 152 moves below the locking portion 115A, and the fixed portion 152 can be locked to the locking portion 115A. As illustrated in FIG. 38, the fixed portion 152 may have a bent portion that is bent upward, and the tip of the fixed portion 152 may be located above the body portion 151.

### Another Example

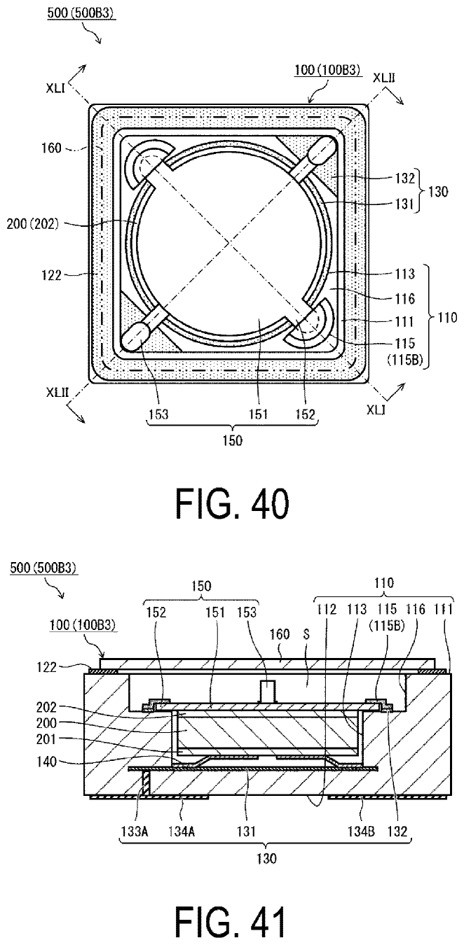

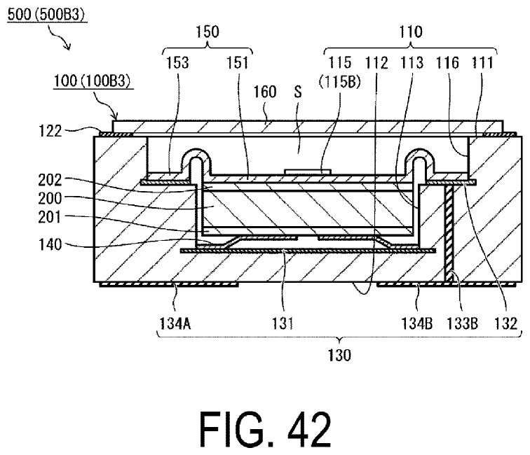

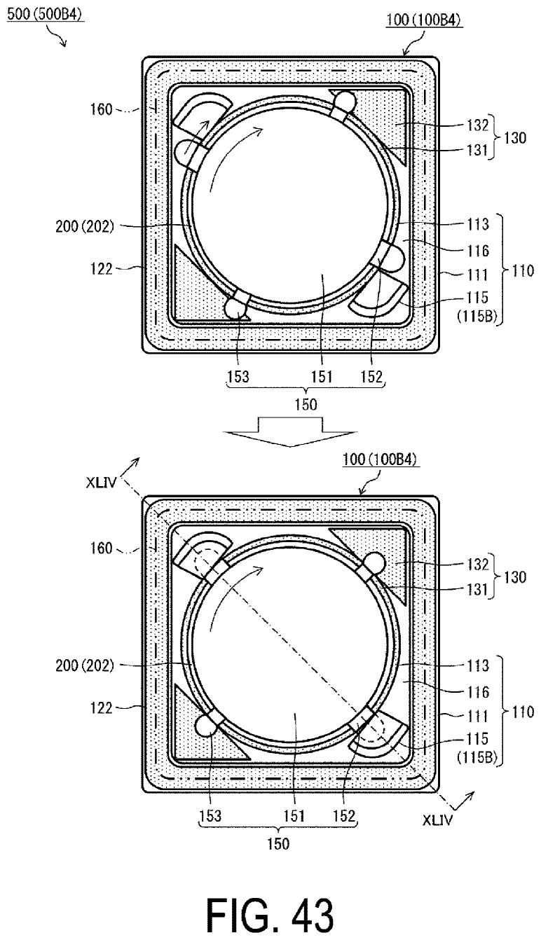

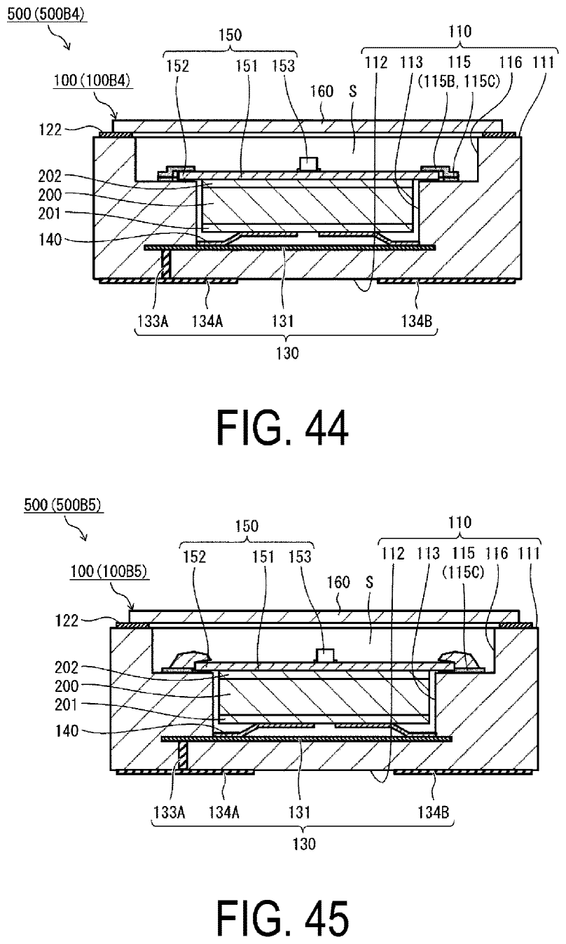

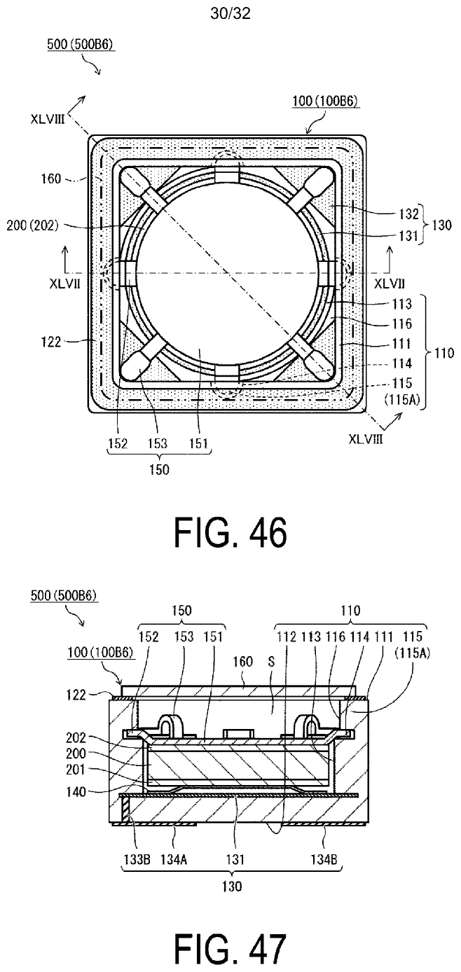

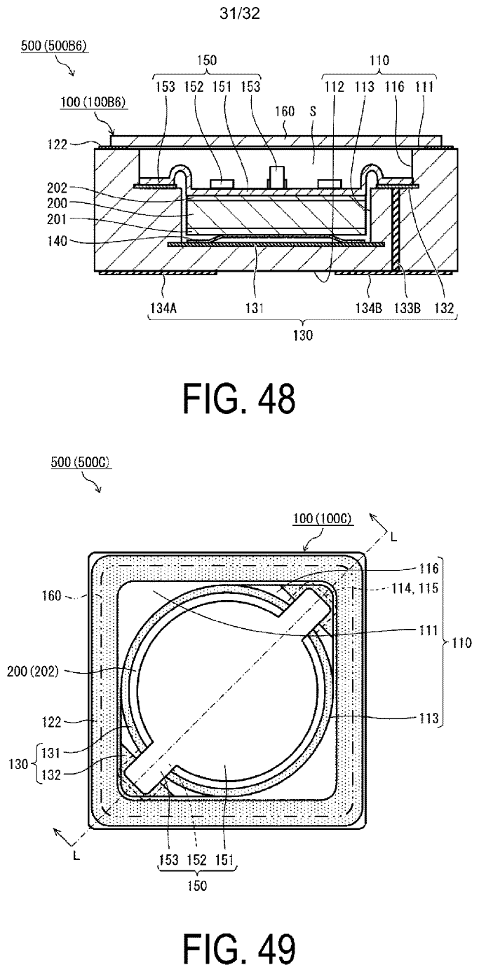

FIG. 40 is a plan view of the battery module 500B3 in which a lid is removed. FIG. 41 is a cross-sectional view taken along line XLI in FIG. 40. FIG. 42 is a cross-sectional view taken along line XLII in FIG. 40. FIG. 43 is a plan view of the battery module 500B4 in which a lid is removed. FIG. 44 is a cross-sectional view taken along line XLIV in FIG. 43. FIG. 45 is a cross-sectional view of the battery module 500B5. FIG. 46 is a plan view of the battery module 500B6 in which a lid is removed. FIG. 47 is a cross-sectional view taken along line XLVII in FIG. 46. FIG. 48 is a cross-sectional view taken along line XLVIII in FIG. 46.

As illustrated in FIGS. 40, 41, 43, and 44, the insulating substrate 110 may include, as the fixing portion 115, for example, a locking fitting 115B fixed or bonded to the insulating substrate 110. As illustrated in FIG. 43, the locking fitting 115B may open laterally to the recessed portion 113. By the rotation of the conductive member 150, the fixed portion 152 is inserted into the locking fitting 115B from the side opening of the locking fitting 115B.

As illustrated in FIG. 45, the insulating substrate 110 may include, for example, a fixing metal film 115C as the fixing portion 115. The fixed portion 152 may be brazed, soldered, or metal welded to the fixing metal film 115C.

As illustrated in FIG. 46, the conductive member 150 may have four connection portions 153 and four fixed portions 152. Alternatively, the conductive member 150 may have three or five or more connection portions 153, and may have three or five or more fixed portions 152. The number of connection portions 153 included in one conductive member 150 may be different from the number of fixed portions 152.

### Third Embodiment

Another embodiment of the present disclosure is described below. Battery modules 500C and 500C2 to be described in the third embodiment are examples of the battery module 500 according to the present disclosure. Battery packages 100C and 100C2 to be described in the third embodiment are examples of the battery package 100 according to the present disclosure.

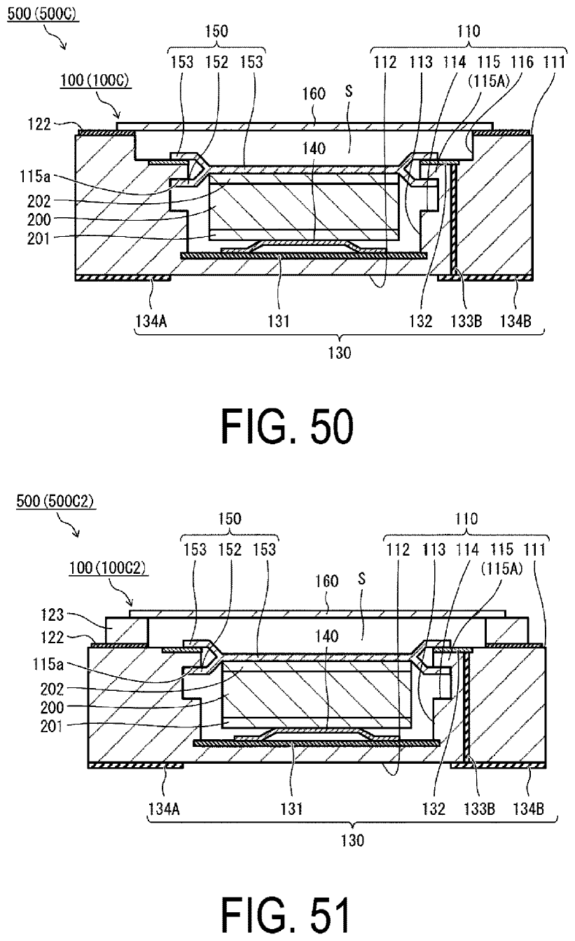

FIG. 49 is a plan view of the battery module 500C in which a lid is removed. FIG. 50 is a cross-sectional view taken along line L in FIG. 49. FIG. 51 is a cross-sectional view of the battery module 500C2. The battery module 500C2 is different from the battery module 500C in that the battery module 500C2 has the metal frame body 123.

As illustrated in FIGS. 49, 50, and 51, in the battery package 100C, the connection portion 153 may at least partially overlap a corresponding fixed portion 152 in top perspective view. The locking portion 115A is interposed between the connection portion 153 and the corresponding fixed portion 152. With this configuration, the conductive member 150 is strongly fixed to the insulating substrate 110. Since the connection portions 153 and the fixed portions 152 are located in the same direction with respect to the center of the recessed portion 113 in plan view, the second electrode 132 is located in the same direction as the locking portion 115A. When the insulating substrate 110 has a rectangular shape in plan view and the battery 200 have a circular shape in plan view, the second electrode 132 is located at the corner portion of the insulating substrate 110, so that the size of the battery package 100 (100C) can be reduced.

As illustrated in FIGS. 50 and 51, the second electrode 132 can be located on the upper surface of the locking portion 115A. Therefore, the second electrode 132 can come into contact with and be electrically connected to the lower surface of the connection portion 153 of the conductive member 150. In addition, the external appearance of the second electrode 132 and the connection between the conductive member 150 and the second electrode 132 can be visually checked. As in the example illustrated in FIGS. 15 and 16, the fixed portion 152 is inserted into the second recessed portion 114 by pushing the conductive member 150. Alternatively, as in the example illustrated in FIGS. 17 and 18, the fixed portion 152 may be inserted into the second recessed portion 114 by rotating the conductive member 150.

As illustrated in FIG. 50, in order to make it difficult for the conductive member 150 to come into contact with the lid 160, the insulating substrate 110 may include the notch 116 that opens to the first surface 110 and the recessed portion 113, and the second electrode 132 may be located on the bottom surface of the notch 116. As illustrated in FIG. 51, the metal frame body 123 and/or an insulating frame body may be located between the insulating substrate 110 and the lid 160 so that the conductive member 150 is less likely to come into contact with the lid 160.

### Conclusion

A first aspect of the present disclosure is a battery package including an insulating substrate including a first surface, a second surface located opposite to the first surface, and a recessed portion opening to the first surface; a first external electrode located on the second surface; a second external electrode located on the second surface; a first electrode located on a bottom surface of the recessed portion and electrically connected to the first external electrode; a second electrode located on the insulating substrate and electrically connected to the second external electrode; a conductive elastic member located on the first electrode; and a conductive member configured to come into contact with an upper surface electrode of a battery accommodated in the recessed portion and to electrically connect the upper surface electrode and the second electrode, wherein the insulating substrate includes a fixing portion configured to limit movement of the conductive member in a direction away from the bottom surface of the recessed portion.

A second aspect of the present disclosure is the battery package according to the first aspect, wherein the second electrode is electrically connected to an upper surface of the conductive member.

A third aspect of the present disclosure is the battery package according to the first or second aspect, wherein the conductive member includes a body portion configured to come into contact with the upper surface electrode of the battery; a connection portion extending outward from the body portion in plan view and configured to be electrically connected to the second electrode; and a fixed portion extending outward from the body portion in plan view and configured to be fixed to the fixing portion.

A fourth aspect of the present disclosure is the battery package according to the third aspect, wherein an extending direction of the connection portion and an extending direction of the fixed portion form an angle.

A fifth aspect of the present disclosure is the battery package according to the third or fourth aspect, wherein the second electrode is electrically connected to a lower surface of the connection portion.

A sixth aspect of the present disclosure is the battery package according to any one of the first to fifth aspects and further includes a plurality of the second electrodes and a plurality of the fixing portions.

A seventh aspect of the present disclosure is the battery package according to the sixth aspect, wherein two of the plurality of the second electrodes are located at positions facing each other across the recessed portion, two of the plurality of the fixing portions are located at positions facing each other across the recessed portion, and a line connecting the two of the plurality of the second electrodes and a line connecting the two of the plurality of the fixing portions form an angle.

An eighth aspect of the present disclosure is the battery package according to any one of the first to seventh aspects, wherein the fixing portion is a locking portion including a locking surface facing the second surface.

A ninth aspect of the present disclosure is the battery package according to the eighth aspect, wherein an upper surface of the locking portion is a stepped surface or an inclined surface approaching a central portion of the recessed portion toward the bottom surface of the recessed portion.

A tenth aspect of the present disclosure is the battery package according to any one of the third to fifth aspects or any one of the sixth to ninth aspects citing the third aspect, wherein the connection portion and the fixed portion overlap each other in top perspective view.

An eleventh aspect of the present disclosure is the battery package according to the tenth aspect, wherein the second electrode is located on an upper surface of the fixing portion and is electrically connected to a lower surface of the connection portion.

A twelfth aspect of the present disclosure is the battery package according to the eighth or ninth aspect, or any one of the ninth to eleventh aspects citing the eighth aspect, wherein the insulating substrate includes a notch opening to the recessed portion below the locking portion and opening to the first surface and the recessed portion at a side of the locking portion.

A thirteenth aspect of the present disclosure is the battery package according to any one of the third to fifth aspects or any one of the sixth to twelfth aspects citing the third aspect, wherein the fixed portion and/or the connection portion includes a curved portion or a bent portion and has elasticity in a direction traversing the body portion.

A fourteenth aspect of the present disclosure is the battery package according to any one aspect of claims 1 to 13, wherein the conductive member is a leaf spring including a protruding portion configured to press the battery from above by vertical inversion at a central portion of the conductive member.

A fifteenth aspect of the present disclosure is the battery package according to any one aspect of claims 1 to 7, wherein the fixing portion is a locking fitting bonded onto the insulating substrate.

A sixteenth aspect of the present disclosure is the battery package according to any one of the third to fifth aspects or any one of the sixth and seventh aspects citing the third aspect, wherein the fixed portion is metal welded in the fixing portion.

A seventeenth aspect of the present disclosure is a battery module including the battery package according to any one of the first to sixteenth aspects; and a battery accommodated in the recessed portion of the battery package.

An eighteenth aspect of the present disclosure is the battery module according to the seventeenth aspect, wherein the battery is an all-solid-state battery.

A nineteenth aspect of the present disclosure is the battery module according to the seventeenth aspect, wherein the battery is a thin-film type all-solid-state battery in which a negative electrode layer, an electrolyte layer, and a positive electrode layer are layered on a metal plate.

A twentieth aspect of the present disclosure is the battery module according to the seventeenth aspect, wherein the battery is a coin cell.

### Supplementary Note

The invention according to the present disclosure has been described above based on the various drawings and examples. However, the invention according to the present disclosure is not limited to each embodiment described above. That is, the invention according to the present disclosure can be modified in various ways within the scope illustrated in the present disclosure, and embodiments obtained by appropriately combining the technical means disclosed in different embodiments are also included within the technical scope of the invention according to the present disclosure. In other words, those skilled in the art can easily make various variations or modifications based on the present disclosure. Note that these variations or modifications are included within the scope of the present disclosure.

### REFERENCE SIGNS

100, 100A, 100B, 100C Battery package
110 Insulating substrate
111 First surface
112 Second surface
113 Recessed portion
115 Fixing portion
115A Locking portion
115a Locking surface
115B Locking fitting
131 First electrode
132 Second electrode
134A First external electrode
134B Second external electrode
140 Elastic member
150 Conductive member
151 Body portion
152 Fixed portion
153 Connection portion
200 Battery
201 Lower surface electrode
202 Upper surface electrode
210 Metal plate
220 Negative electrode layer
230 Electrolyte layer
240 Positive electrode layer
500, 500A, 500B, 500C Battery module

1. A battery package comprising:
an insulating substrate comprising a first surface, a second surface located opposite to the first surface, and a recessed portion opening to the first surface;
a first external electrode located on the second surface;
a second external electrode located on the second surface;
a first electrode located on a bottom surface of the recessed portion and electrically connected to the first external electrode;
a second electrode located on the insulating substrate and electrically connected to the second external electrode;
a conductive elastic member located on the first electrode; and
a conductive member configured to come into contact with an upper surface electrode of a battery accommodated in the recessed portion and to electrically connect the upper surface electrode and the second electrode,
wherein the insulating substrate comprises a fixing portion configured to limit movement of the conductive member in a direction away from the bottom surface of the recessed portion.

2. The battery package according to claim 1, wherein the second electrode is electrically connected to an upper surface of the conductive member.

3. The battery package according to claim 1, wherein the conductive member comprises:
a body portion configured to come into contact with the upper surface electrode of the battery;
a connection portion extending outward from the body portion in plan view and configured to be electrically connected to the second electrode; and
a fixed portion extending outward from the body portion in plan view and configured to be fixed to the fixing portion.

4. The battery package according to claim 3, wherein an extending direction of the connection portion and an extending direction of the fixed portion form an angle.

5. The battery package according to claim 3, wherein the second electrode is electrically connected to a lower surface of the connection portion.

6. The battery package according to claim 1, further comprising a plurality of the second electrodes and a plurality of the fixing portions.

7. The battery package according to claim 6, wherein two of the plurality of the second electrodes are located at positions facing each other across the recessed portion,
two of the plurality of the fixing portions are located at positions facing each other across the recessed portion, and
a line connecting the two of the plurality of the second electrodes and a line connecting the two of the plurality of the fixing portions form an angle.

8. The battery package according to claim 1, wherein the fixing portion is a locking portion comprising a locking surface facing the second surface.

9. The battery package according to claim 8, wherein an upper surface of the locking portion is a stepped surface or an inclined surface approaching a central portion of the recessed portion toward the bottom surface of the recessed portion.

10. The battery package according to claim 3, wherein the connection portion and the fixed portion overlap each other in top perspective view.

11. The battery package according to claim 10, wherein the second electrode is located on an upper surface of the fixing portion and is electrically connected to a lower surface of the connection portion.

12. The battery package according to claim 8, wherein the insulating substrate comprises a notch opening to the recessed portion below the locking portion and opening to the first surface and the recessed portion at a side of the locking portion.

13. The battery package according to claim 3, wherein the fixed portion and/or the connection portion comprises a curved portion or a bent portion and has elasticity in a direction traversing the body portion.

14. The battery package according to claim 1, wherein the conductive member is a leaf spring comprising a protruding portion configured to press the battery from above by vertical inversion at a central portion of the conductive member.

15. The battery package according to claim 1, wherein the fixing portion is a locking fitting bonded onto the insulating substrate.

16. The battery package according to claim 3, wherein the fixed portion is metal welded in the fixing portion.

17. A battery module comprising:
the battery package according to claim 1, and
a battery accommodated in the recessed portion of the battery package.

18. The battery module according to claim 17, wherein the battery is an all-solid-state battery.

19. The battery module according to claim 17, wherein the battery is a thin-film type all-solid-state battery in which a negative electrode layer, an electrolyte layer, and a positive electrode layer are layered on a metal plate.

20. The battery module according to claim 17, wherein the battery is a coin cell.
